(19) United States
(12) Patent Application Publication
(10) Pub. No.: US 2004/0044684 A1
(43) Pub. Date: Mar. 4, 2004

(54) Management tracking system and method of use

(76) Inventors: Clark Easter, Monkton, MD (US); Michael Jin, Cockeysville, MD (US); Theodosia E. Ewers, Mount Savage, MD (US); Amy H. Koren, Pikesville, MD (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/455,804

(22) Filed: Jun. 6, 2003

Related U.S. Application Data
(60) Provisional application No. 60/385,877, filed on Jun. 6, 2002.

(51) Int. Cl. G06F 17/00

(52) U.S. Cl. 707/103 R

(57) ABSTRACT

A method and system for providing compliance with a management scheme, such as the Individuals with Disabilities Education Act, and a method and system for tailoring the management scheme to management entity requirements. One variation allows inclusion of multiple management entities in an application/database, with configuring and processing for each individually. More than one management scheme can be extant for each management entity. The management scheme allows information input regarding entities subject to the scheme, requirements identification regarding each entity, and iterative generation of additional input to ensure compliance with the management scheme. One entity can be subject to more than one management schemes. The tailoring method and system include identifying management entity-specific data options and rules, comparing the options and rules to a master set, linking options and rules of the management entity to corresponding master items, and adding data options and rules lacking corresponding master items.

This application claims priority from U.S. Provisional Application Serial No. 60/385,877 filed Jun. 6, 2002. The entirety of that provisional patent application is incorporated herein by reference.

### BACKGROUND OF THE INVENTION

1. Field of the Invention

The present invention relates to a software based method and system for tracking and supporting compliance with a management scheme for individualized educational instruction, behavioral interventions or social interventions, and in particular to a software based method and system for tracking of, supporting compliance with, and otherwise assisting in meeting a set of requirements consistent with that kind of individualized management scheme.

2. Background of the Technology

There is an unmet need in the art for methods and systems for the tracking of, supporting compliance with, and otherwise providing assistance in meeting requirements for the complex and sophisticated management schemes that institutions need to use in order to effectively and efficiently manage mandated individualized instructional paths, disciplinary/rehabilitative paths, or social intervention paths for hundreds if not thousands of students, juveniles, etc., simultaneously, all with different start and end dates, and different internal individualized management steps. For example, looking at mandated individualized instructional paths, it is not uncommon to find that a U.S. public K-12 school district may need to manage 30% or more of its student population under individualized instructional programs such as Special Education, 504, English Second Language, Early Intervention/Student Support Team, Gifted and Talented, or At Risk of Failing High Stakes Exit Exams. Each of these programs consists of requirements involving events or meetings (such as Referrals, or Annual Meetings or Reevaluation Meetings), associated timelines, linked paperwork, and mandated outcomes. Successful, consistent, legally compliant execution of these individualized programs by a school district requires the tight coordination of dozens of action steps across multiple team members for each affected child within relatively short time periods. Failure to effectively manage, what in many school districts may be thousands of individualized instructional paths going on simultaneously, significantly diminishes the education effectiveness of these interventions, exposes the district to serious legal liability for violating Federal and State law, risks loss of full Federal and State funding, and drives up a districts administrative overhead.

All of these individualized instructional paths (or behavioral/rehabilitative/social intervention paths such as managing juvenile services, etc.) point to the ability of a software based method and system for tracking and supporting compliance with a management scheme around events, outcomes, timelines, and associated paperwork. The appropriate database structure could simplistically be said to track the “Who needs to do what? When do they need to do it by? Did they do it? When did they do it? And if they were late, why were they late?” At the teacher or staff level, such a database structure needs to support staff at any point in time in knowing explicitly what they need to do, and when do they need to do it by. At the administrator level, such a database structure needs to let administrators manage to district standards for performance, allowing transparent accountability of district wide performance, regional performance, building or site performance, and even down to the individual provider performance.

### SUMMARY OF THE INVENTION

The present invention provides a database structure and platform that embodies an effective method and system for tracking, supporting compliance with, and otherwise assisting in meeting management requirements, such as institutionally-provided and/or legally mandated requirements for individualized instruction, behavioral intervention or rehabilitation, or social work or judicial intervention and/or tracking.

One embodiment of the present invention provides a method and system that include a number of functionally and interactively integrated components for assistance with meeting requirements for entities (e.g., individuals) within organizations to which the requirements apply, referred to herein as “management entities” (and interchangeably referred to herein as “clients”), such as school districts, counties, or states seeking to ensure compliance with IDEA, (the Individuals with Disabilities Education Act—the Federal law mandating Special Education for Individuals with Disabilities), or with English Second Language, or with 504, or with other mandated programs for special populations within a school district or state. In one embodiment, the method and system include one or more data repositories (e.g., databases) associated with the components, which allow entry and interrelation of data among the components. In one embodiment, the components are directed to activities relating to compliance, tracking, or other functions. In one embodiment relating to implementation for compliance with the IDEA, the components include the following: 1) compensatory/violations; 2) school and codes information; 3) event/meeting timelines and outcomes, planning and other information; 4) Individual Education Plan (IEP) tracking and information maintenance; 5) discipline information; and 6) student master information.

One embodiment of the present invention further provides a method and system for rapidly tailoring or customizing compliance requirements and other functions for each management entity. The present invention provides a database structure and platform for rapidly configuring/customizing the database structure to mirror the school district's or county's or state's agreed upon business process surrounding meeting/events, timelines, outcomes, and associated paperwork.

School districts or other management entities have traditionally tried to manage these special populations with their thousands of individualized instructional paths by throwing more staff at the problem, and by using home grown solutions, such as spreadsheets or tickler files. No national solution was emerging, because although there was Federal Law (IDEA), each state had a different interpretation of that law, as permitted by state's rights, and many districts had yet another level of interpretation, as permitted under local autonomy. As a result, no “one size fits all”, hard coded database solution was possible, because timelines, events, outcomes, and even terminology was different from district to district all over the U.S. Further complicating the picture is that the rules and timelines are changing constantly all over the country, due to Federal, state, or local law or procedural changes. For example, Federal changes to the IDEA law this year will take several years to trickle down to the district level as they pass through the different layers of government. This has a tremendous impact on the necessary database structure to adequately manage these special populations, because it must allow the preservation of the historical data and the governing rules, while simultaneously allowing for correct processing under new law. The present invention solves these challenges, as well as others, and allows a national solution by allowing for rapid configuration/customization of the invention's data structure to mirror a district's business process. The present embodiment also allows the rules governing a special population to change across time, while preserving the historical data/process.

Yet another addressed complication for the necessary database structure is that an individual student, with the present invention, may be managed under more than one path simultaneously. For example, a student going through the Special Education process may also simultaneously be going through the English Second language instructional path, or though a behavioral intervention process. The database design of the present invention accommodates for this, and allows for individual students to be in more than one work flow simultaneously.

The present invention also includes the database structures to accommodate transparent accountability so that, among other things, the management entity can look at data entity wide, or drill down to regional views of data, or to site views, or to individual provider views in order to evaluate compliance with entity management standards.

For example, for IDEA compliance, the present invention allows the management method and system to be initially tailorable/configurable to the requirements of a particular school district or other management entity maintaining information. Tailoring includes determining a management entity's data options and rules, appropriately identifying any corresponding data options and rules in a master repository linking the corresponding data options and rules, and adding, as necessary, each data option and rule of the management entity's particular scheme for implementation.

In one embodiment of the present invention, these tailoring functions include comparison of each of the management entity's procedures, referred to in one embodiment of the present invention as “events,” to a master group of procedures in a repository or other data structure of the system of the present invention. The master procedures that match the management entity's procedures are tailored to the management entity's naming scheme and other particular characteristics, such as timelines, for that procedure for the management entity. Additional, varied procedures are optionally addable to the system for that management entity. Each procedure is then matched to one or more additional results or further actions, referred to in one embodiment as “outcomes.” Rules or other requirements for each matching pair of events and outcomes are included in a management entity repository or other data structure of the system.

The tailored system is then used to assist with compliance and tracking of information for the customized management scheme. For example, for IDEA implementation, information is input for each new student entering the system. The system and method of the present invention automatically assist the accessor (also referred to interchangeably herein as “user”) in a tailored manner (e.g., via operation of the customized rules) with inputting the proper information to the system for the particular student. For example, the system may prompt the accessor to provide the full name, address, and other identifying information for the student, the student's school, and information relating to the student and relevant to the system's purpose, such as the student's suspected or known disability, features relating to evaluation, and other next steps in the management entity's procedure. Because the method and system have been tailored to the particular management entity, each step in the management entity's procedure is automatically presented to the inputter for completion or followup and is consistent with the management entity's particular scheme (e.g., names used, timelines mandated, data requirements).

The tailored rules, for example, may automatically calendar an evaluation or other assessment or delivery of one or more services by a particular date, and require inputs for meetings relating to the evaluation. Depending upon the combination of events and outcomes specified, the future events/obligations generated may vary. For example, if parent permission is obtained, the generated future obligation could be an annual review meeting due in one year: if parent permission is not obtained, the generated future obligation could be the obtaining of parent permission.

Via the customized method and system, any paperwork or other requirements relating to the management entity's procedures, as well as any legal or other requirements applicable to the program as a whole, are automatically prompted for, and compliance with these requirements is tracked. For example, if a meeting with the student's parents is required, along with specific approval for the student's plan, the system and method of the present invention require scheduling of and follow up on the meeting, input of the meeting's occurrence following scheduled completion, and assistance with confirmation of completion of required approval forms.

The system of one embodiment of the present invention includes a graphical user interface (GUI) for input and other interaction by those accessing the system. In one embodiment, the GUI includes a visual representation of underlying tables that looks and behaves like a series of interacting spreadsheets or other repository data controls that link the various parts of the management entity's procedures to data option and rules, so as to provide tailored prompting and other assistance with meeting management scheme requirements. In one embodiment of the present invention, accessors are not provided with the capability of directly interacting with the spreadsheets or other repository data controls, so that rules and/or requirements may not be circumvented easily.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the figures:

FIG. 1 presents an example timeline for various activities relating to a management scheme, in accordance with an embodiment of the present invention;

FIG. 2A shows an example event matrix for use with customization of a management scheme for a management entity, in accordance with an embodiment of the present invention;

FIG. 2B is an example worksheet for use in conjunction with customizing a management scheme for a management entity, in accordance with an embodiment of the present invention;

FIG. 3 presents an example master list of events for an exemplary management scheme implementation for IDEA compliance, in accordance with an embodiment of the present invention;

FIG. 4 is an example list for linking master events to user customized events, in accordance with an embodiment of the present invention;

FIG. 5 shows a first example table for linking event types and outcomes, in accordance with an embodiment of the present invention;

FIG. 6 contains an example table for restricting correlation of meeting types and outcomes, in accordance with an embodiment of the present invention;

FIG. 7 presents an example portion of a timeline feature for use in developing tables to support a management scheme system, in accordance with an embodiment of the present invention;

FIG. 8 shows an example business rule table (e.g., master list of future record rules), in accordance with an embodiment of the present invention;

FIG. 9 is an example rules table for IDEA implementation (e.g., client-specific list of future record rules), in accordance with an embodiment of the present invention;

FIG. 10 presents an example GUI screen showing a customizable label, in accordance with an embodiment of the present invention;

FIG. 11 illustrates a table for allowing customization of labels, buttons, and tabs, in accordance with an embodiment of the present invention;

FIG. 12 contains an example illustrating the capability of the present invention to support the customization of items in dropdown lists (e.g., an example table and selection screen for selecting a user-customized preference for ethnic origin), in accordance with an embodiment of the present invention;

FIG. 13 is an example GUI screen with customized selections for ethnic origin presented, in accordance with an embodiment of the present invention;

FIG. 14 presents an example management scheme system diagram for use with a network, such as the Internet, in accordance with an embodiment of the present invention;

FIG. 15 contains a block diagram of various computer system components for implementation of a management scheme, in accordance with an embodiment of the present invention;

FIG. 16 shows an example network access GUI interface, in accordance with an embodiment of the present invention;

FIG. 17 presents an individual user login GUI interface screen, in accordance with an embodiment of the present invention;

FIG. 18 shows a specific customization and entity selection confirmation presented for a particular school district and school, for an IDEA implementation of a management scheme, in accordance with an embodiment of the present invention;

FIG. 19 is an example GUI screen presenting an interaction screen for an accessor, in accordance with an embodiment of the present invention;

FIG. 20 presents an example student list search option GUI screen, in accordance with an embodiment of the present invention;

FIG. 21 contains an example student search GUI screen for finding a particular student, in accordance with an embodiment of the present invention;

FIG. 22 shows a sample results list GUI screen for a student search, in accordance with an embodiment of the present invention;

FIG. 23 is an example special education student folder transfer GUI screen, in accordance with an embodiment of the present invention;

FIG. 24 presents an example student search GUI screen for finding a particular student, in accordance with an embodiment of the present invention;

FIG. 25 contains a sample results list GUI screen for a student search, in accordance with an embodiment of the present invention;

FIG. 26 shows an example student detail GUI screen for use in viewing and inputting information relating to a student subject to a management scheme, in accordance with an embodiment of the present invention;

FIG. 27 is an example special education student folder transfer GUI screen, in accordance with an embodiment of the present invention;

FIG. 28 presents an example student detail GUI screen showing various school transfer related activity (e.g., a manage transfer, which means the school responsible for overseeing special education has changed), in accordance with an embodiment of the present invention;

FIG. 29 contains an example student detail GUI screen showing a drop down menu for exit reason, in accordance with an embodiment of the present invention;

FIG. 30 shows an example student detail GUI screen, in accordance with an embodiment of the present invention;

FIG. 31 is a sample results list GUI screen for a student search relating to student meeting types and outcomes, in accordance with an embodiment of the present invention;

FIG. 32 presents an example meeting detail GUI screen showing student meeting types and outcomes information, in accordance with an embodiment of the present invention;

FIG. 33 contains an example meeting detail GUI screen for a student (e.g., including due date for a meeting), in accordance with an embodiment of the present invention;

FIG. 34 shows an example meeting detail GUI screen showing post initial activities for a student with newly input information, in accordance with an embodiment of the present invention;

FIG. 35 is a sample IEP revisions option GUI screen for a student (e.g., the initial screen for a new IEP, when developed, which allows the user to enter the new IEP and services prescribed), in accordance with an embodiment of the present invention;

FIG. 36 presents a main information GUI screen for IEP revisions options, in accordance with an embodiment of the present invention;

FIG. 37 contains a main information GUI screen for IEP revisions options with newly added information shown, in accordance with an embodiment of the present invention;

FIG. 38 shows an example meeting detail GUI screen for student information for use for Multidisciplinary Evaluation Team (MET) review, in accordance with an embodiment of the present invention;

FIG. 39 is an example meeting detail GUI screen showing input MET information, in accordance with an embodiment of the present invention;

FIG. 40 presents an example meeting detail GUI screen for student information for use for initial Individual Education Plan Team (IEPT) use (including an example “IEP Develop” event occurring on the same date), in accordance with an embodiment of the present invention;

FIG. 41 contains an example meeting detail GUI screen for student information for use for initial Evaluation Review Meeting (ERM) use and obtaining consent, in accordance with an embodiment of the present invention;

FIGS. 42A and 42B show the login to the same database on the same server that contains information for two different management entities, in accordance with an embodiment of the present invention;

FIGS. 43A and 43B show looking at a student in each of the two districts, with a variation in the labels displayed, in accordance with an embodiment of the present invention;

FIGS. 44A and 44B show looking at an IEP for a student in each of the two districts, with a variation in the labels and fields displayed, in accordance with an embodiment of the present invention;

FIGS. 45A and 45B show looking at the LRE codes for each of the two districts, with the difference in values displayed, in accordance with an embodiment of the present invention;

FIGS. 46A and 46B show looking at the list of schools for each of the two districts, with the difference in schools displayed, in accordance with an embodiment of the present invention;

FIGS. 47A and 47B show looking at the list of providers for each of the two districts, with the difference in providers displayed, in accordance with an embodiment of the present invention;

FIG. 48 illustrates the limitation on permissions that can be placed on a user within the application, depending upon the school(s) to which the user is displayed, in accordance with an embodiment of the present invention;

FIGS. 49A and 49B show the variation in code values displayed, depending upon the effective dates of the codes and the date on which the code values are dependent, in accordance with an embodiment of the present invention;

FIG. 50 illustrates the four school linkages that are tied to the student, in accordance with an embodiment of the present invention; and

FIG. 51 illustrates the one school that is assigned to a specific instance of delivery of a service, in accordance with an embodiment of the present invention.

### DETAILED DESCRIPTION

Various features of this application are disclosed in or interact with one or more features of applicant's following copending provisional and utility patent applications: U.S. patent application Ser. No. 10/406,246 filed Apr. 4, 2003, titled “Method and System for Online Analytical Processingfor Educational and Other Outcomes”; U.S. Patent Application Serial No. 60/406,046 filed Aug. 27, 2002, titled “Method and System for EZ Compliance”; and U.S. Patent Application Serial No. 60/422,869 filed Nov. 1, 2002, titled “Encounter Tracker and Service Gap Analysis System and Method of Use”. The entirety of each of these patent applications is incorporated herein by reference.

The present invention includes methods and systems for providing compliance with a management scheme. The management scheme can be any individualized process for implementation, whether of individualized instruction, behavioral or social intervention. One embodiment further includes a method for tailoring the management scheme compliance system to an entity's specific requirements without the necessity of modifying program language code. Thus the customization for one management entity in no way affects the customization for another management entity and can be accomplished very quickly. Among other things, the management scheme method and system allow information to be input regarding an entity subject to the scheme, such as an individual student, requirements to be identified regarding the entity, and iterative prompts to be generated for additional input to ensure compliance with each aspect of the management scheme. In one implementation of an embodiment of the present invention, the management scheme involves compliance with various requirements of the Individuals with Disabilities Education Act, and the detailed examples provided hereafter are drawn from that particular management scheme. It should also be noted that one entity, such as an individual student, can be subject to more than one management scheme simultaneously, and that the type of management scheme is not limited to that related to implementation of IDEA.

A. Method and System for Customization for a Management Entity

One embodiment of the present invention includes customizing the system for a particular management entity (e.g., institution using the system). In one variation, in a first stage of customization, information is initially gathered from the management entity. For example, a meeting may be held with someone from a school who knows their particular implementation of the special education process under the IDEA.

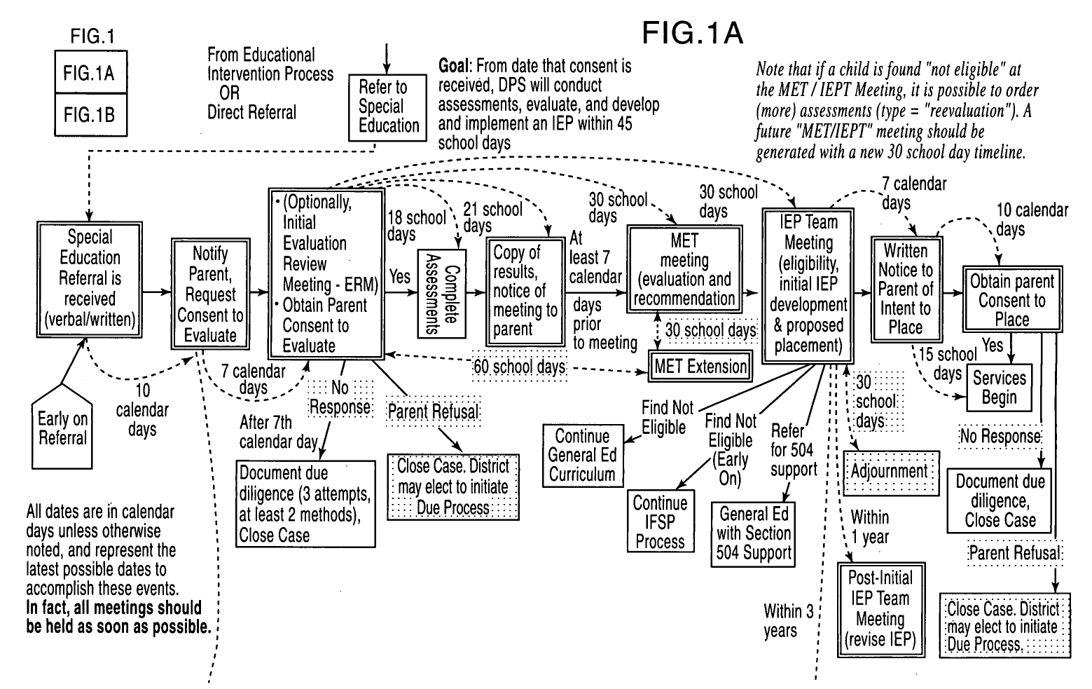

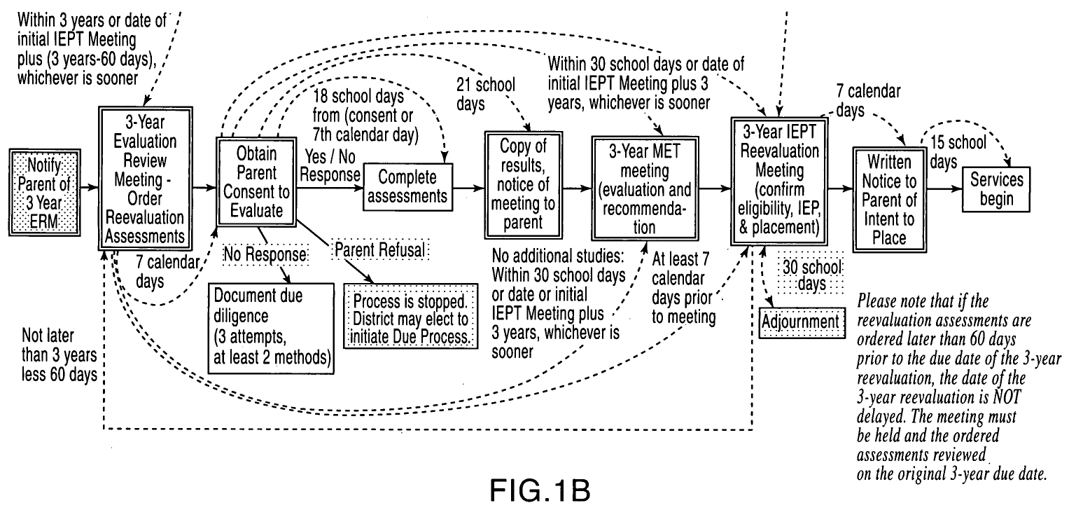

First Step: Gathering Business Rules. FIG. 1 presents an example timeline for various activities relating to a compliance scheme, in accordance with an embodiment of the present invention. In this embodiment, the timeline of activities is referred to as a timeline of the “business rule process.” As shown in the example of FIG. 1, this timeline includes the key meetings, their order, when each is due, and under what circumstances. In this example, the timeline will become the basis of the business rule table or other repository element within the system for this management entity, which is involved in implementation of special education tracking (referred to interchangeably herein for purposes of this particular illustrative example as the “Special Education Tracking System” or SETS).

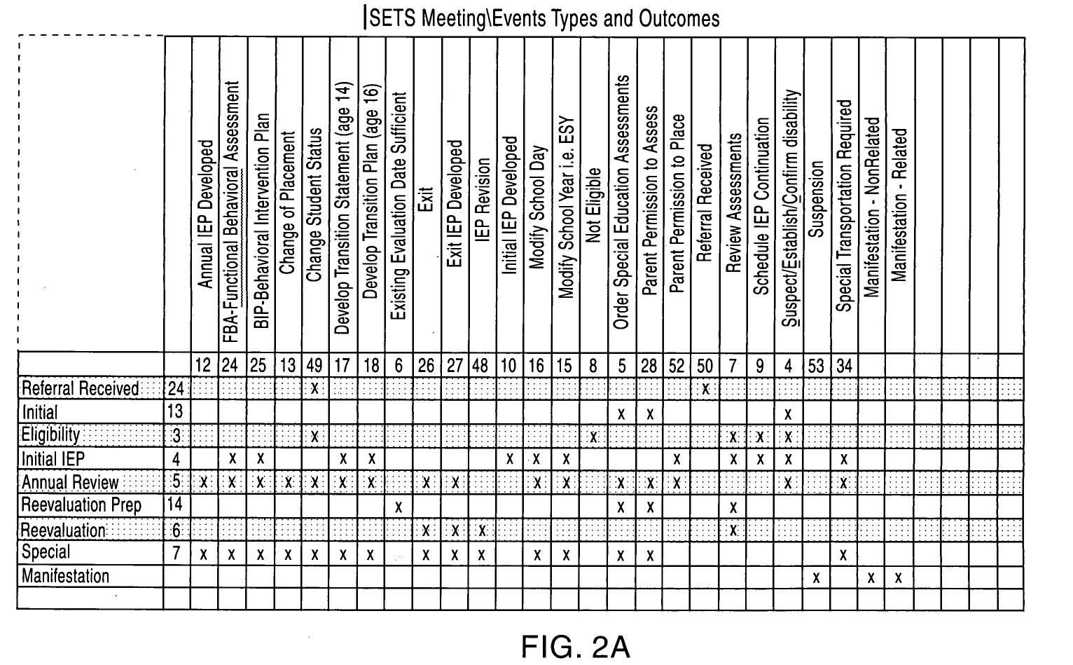

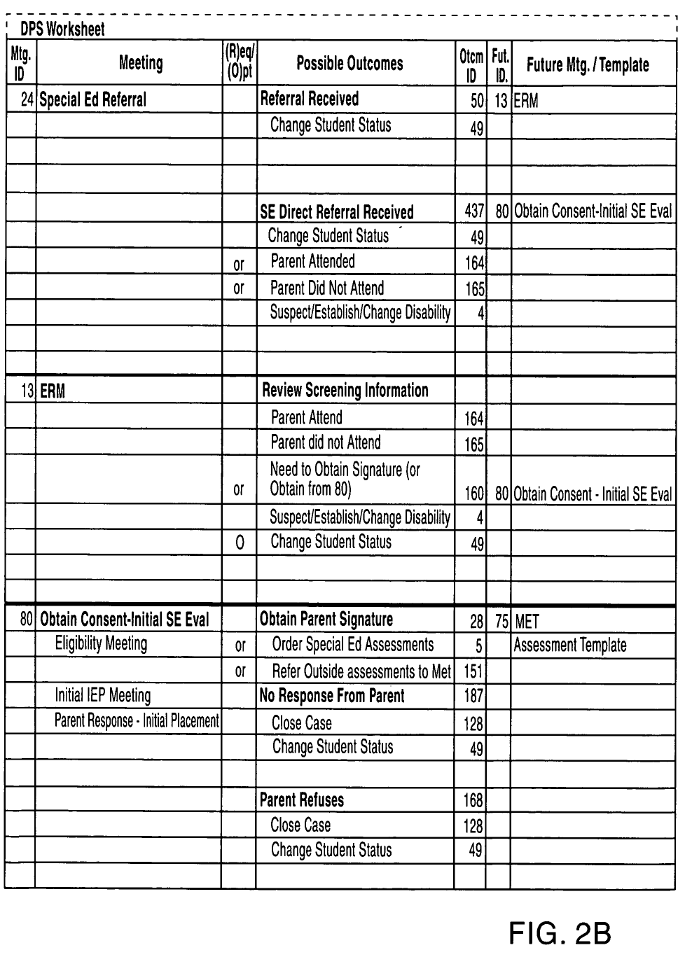

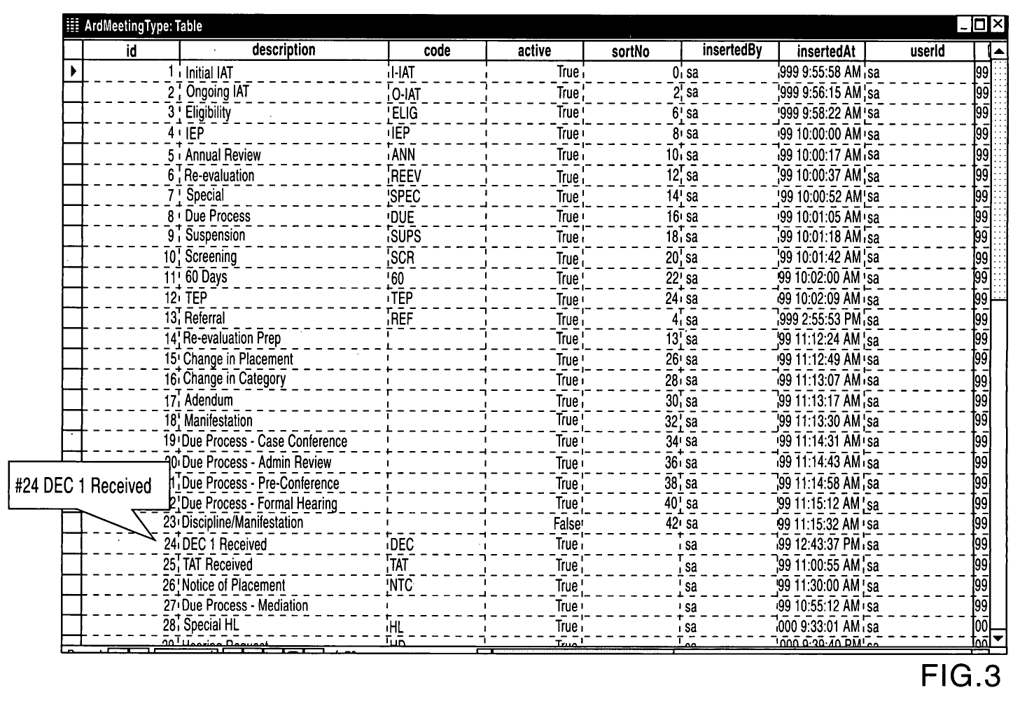

Second Step: Customizing Events. In one embodiment, the next step in the customization process involves reviewing each event type, determining the possible outcomes for each event, and evaluating which of those outcomes are required under various circumstances. To assist with this process, in one embodiment, an event matrix is created, such as the example matrix shown in FIG. 2A. In addition, worksheets may be prepared to further assist with the process. For example, FIG. 2B presents a sample worksheet for linking events (meetings this example) with possible outcomes, along with the associated indicated identification numbers for the particular example presented (these identification numbers are described further below in conjunction with FIGS. 3-6).

After sufficient information to begin customizing the business process has been gathered, a customized table or other data set of events and outcomes is developed. For example, for the exemplary embodiment relating to implementation with regard to the IDEA, an all Meeting Types and Outcomes specialized spreadsheet or group of spreadsheets is developed for certain events. In this example, customization is developed using a master list of all meetings, which is used by all management entities using the system. A comparison is initially made between the list of events the particular management entity for which customization is being accomplished requires, and the master list, in order to determine if all of the required events are present, even though the names may be different (e.g., in the present example, many meetings may be universal or widely similar for management entities, but referred to locally by specific names that are not universal).

FIG. 3 presents an example master list of meetings for an exemplary implementation for compliance with the IDEA, in accordance with an embodiment of the present invention. In FIG. 3, the management entity specified event listed as “Referral Received” in FIG. 2 corresponds on the list in FIG. 3 to the indicated item #24, “DEC 1 Received.” In this embodiment, if a corresponding master list event had not been found, a new event would have been added to the master list.

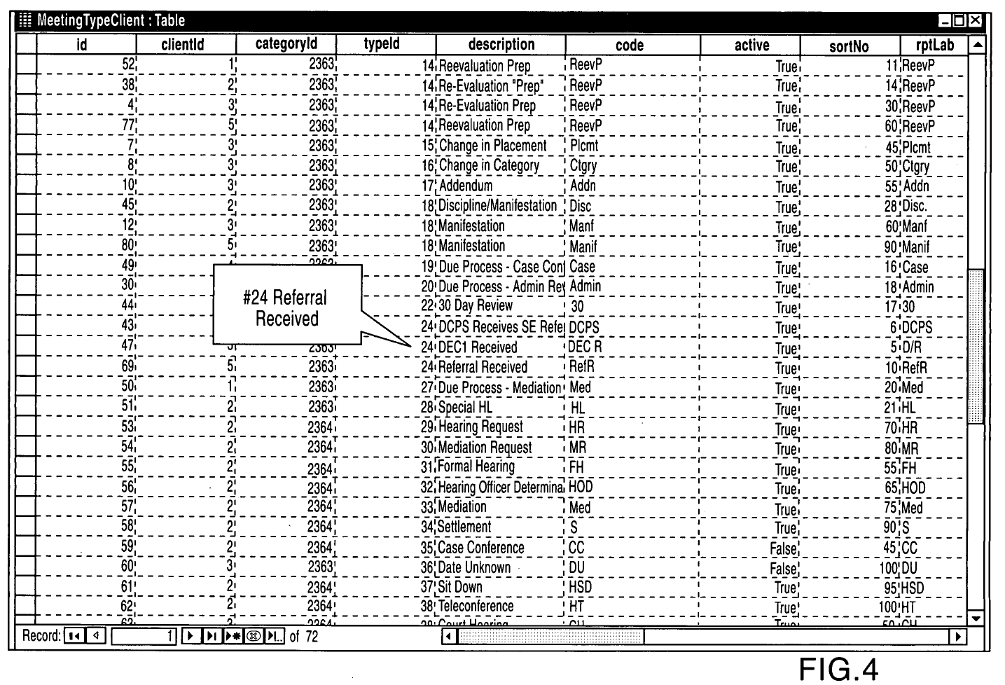

Event #24 is then set up for the management entity on an event list for linking the master event to an event customized for the management entity. For example, as shown in FIG. 4, the event “Referral Received” is added to the event list. Note that, as shown in the example of FIG. 4, two other management entities have item #24 in their customized systems, referred to, respectively, as “DEC 1 Received” and “DCPS Receives SE Referral.”

A similar structure to the exemplary “master” and “client” structure shown in FIG. 4 is used throughout the present invention. This approach provides the control of having one list with one set of master codes, but also allows each management entity to select the codes preferred, and to call each item whatever they like. Additional benefits of this approach are that the master list provides identification of the type of code to be displayed in a particular dropdown box, while the values displayed are those of the specific client; and that a single version of a standard report can be developed that can be used by multiple clients because the code type is identified from the master list, but the code values are drawn from the client-specific tables.

Third Step: Linking Events to Outcomes

Once the customized events are included on the list, all rules associated with the events must be customized. First meetings are linked to outcomes using, for example, the information from the matrix shown in FIGS. 2A and 2B. The linking creates a list of all possible outcomes for each event type, but does not indicate the circumstances necessary to use those outcomes; the linking thus serves as a first step in the event rule process. As with the previous step, a master list of rules is provided, from which appropriate tailored rules may be assigned to the management entity.

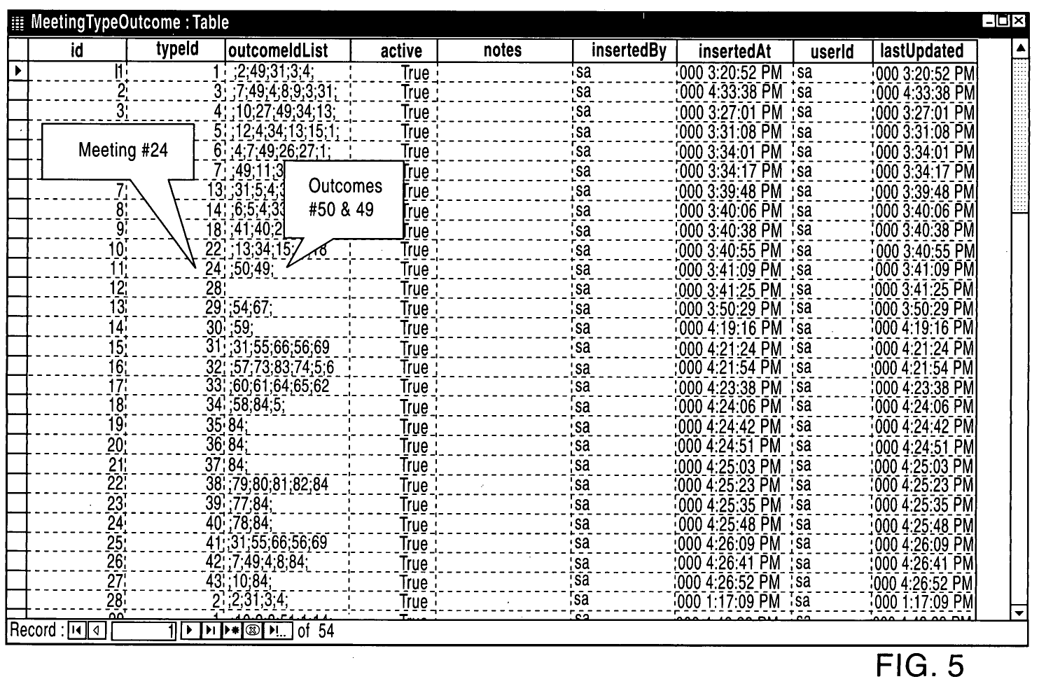

FIG. 5 shows a first table for linking event types and outcomes, in accordance with an example implementation of the present invention. As indicated, the event and outcome linking table of FIG. 5 shows that the “Referral Received Meeting” (#24) can have two possible outcomes: #50 and #49. Since the management entity has required this rule, this rule is assigned for the management entity and becomes a part of the system logic for that management entity, as also described further below with regard to the GUI screen portion of the system.

In addition, note that certain outcomes of the table shown in FIG. 5 can, in turn, produce additional events and corresponding outcomes, so that a chain or somewhat iterative process is produced for a series of events and outcomes. In an embodiment of the present invention, these iterative logic chains, which are somewhat similar to decision trees, intelligently assist accessors of the system with meeting compliance requirements by necessitating completion of each portion of the iterative process. (The iterative process for accessor completion is also described further below with regard to the GUI portion of the system.)

For example, if an accessor is inputting a particular event type (e.g., meeting) that has been requested, this meeting may have only certain possible outcomes (which are presented to the accessor), and certain follow up events (e.g., paperwork requirements) may in turn be triggered at certain dates. Each of these linked events “iteratively” requires completion by the accessor, thereby assisting with ensuring compliance with this aspect of the management scheme. This functionality is especially useful for supporting quick customization of the application to support the specific needs of a management entity.

The present invention also contains features allowing a variety of “counting” mechanisms for time periods involved in the timeline for the management scheme. For example, for IDEA implementation for a management entity, time periods may be measured by calendar days, school days, or (business) weekdays. The present invention includes features that allow automatic generation of due dates and other timeline dates that vary depending on the input time period measurement type and that take a specific management entity's schedule into account. For example, each school in a larger management entity (e.g., district) can be linked to two calendars: a school calendar and a business calendar. One or both of those calendars can be a general district calendar, or can be a school-specific calendar.

Although “school” and “administrative region” can be used literally to represent a physical school or administrative region, it is also possible for a management entity to define “conceptual” schools and regions in order to manage particular groups of students more effectively. For example, young children can be grouped into three “Schools” called “Headstart,” “Natural Environment,” and “Preschool” if that grouping corresponds to a management entity's administrative needs. In addition, a management entity can include schools that are not budgetarily within its scope but to whose students it provides services (such as private and parochial schools), and it can choose to group those schools into a region called “Private and Parochial Schools.”

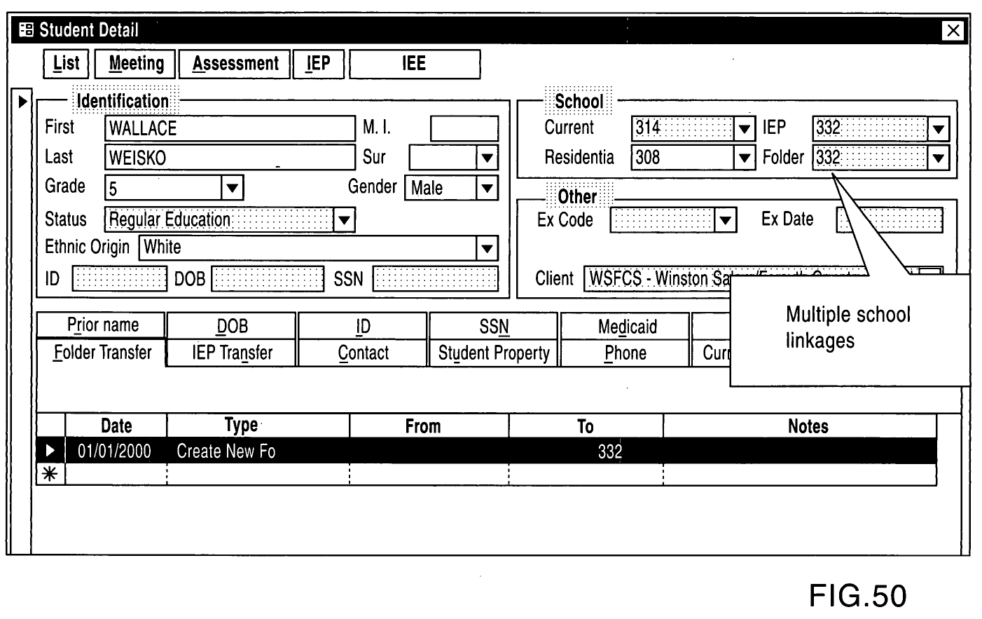

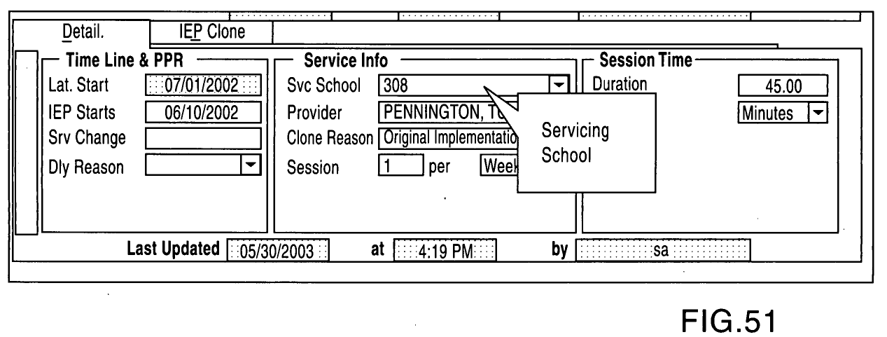

In addition, it is normal during the course of a management scheme for an entity subject to that scheme to have linkages to more than one “school”. See, e.g., FIGS. 50 and 51 below for an illustration of this application. In an embodiment of the present invention, the student in FIG. 50 is attending school “314” (“Current”) whereas his neighborhood school is “308” (“Residentia”). His services are being coordinated by school “332” (“IEP”), and his folder is held by school “332” (“Folder”). In FIG. 51, one of his services is being delivered by school “308” (“Svc School”). Each school responsible for a designated portion of this student's information and services can be identified, and there is no requirement for all of the school values to be the same.

Step Four: Event Logic Rules

Next controls are set as to when a given outcome can be selected. For example, in the case of the exemplary system directed to IDEA compliance, the outcomes “Not Eligible” and “Initial IEP Created” may both be possible outcomes for an event (e.g., a meeting), but it would not make sense to select both at the same event, since, under the rules specific to this implementation example, a subject entity (e.g., a student) cannot have an IEP if they are not eligible for Special Education. Therefore, to control which events and outcomes can be selected together, must be selected together, or can never be selected together, “Match Rules” and “No Match Rules” are created in a matching rules logic table or other repository features.

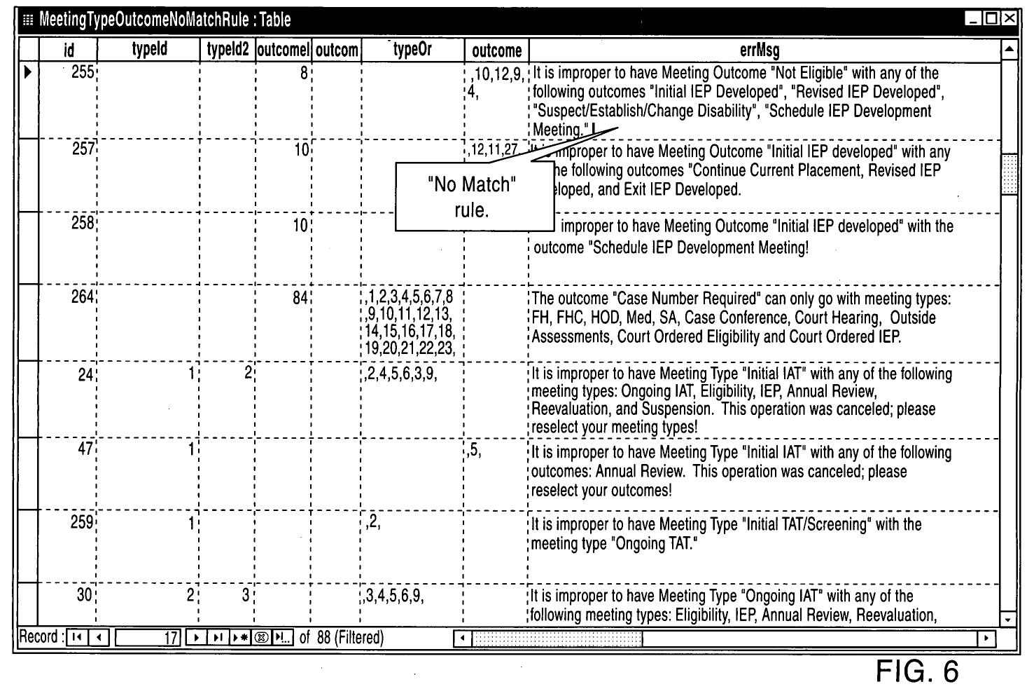

FIG. 6 contains an example table for restricting correlation of meeting types and outcomes, in accordance with an embodiment of the present invention. In the example shown in FIG. 6, the “No Match Rule” prevents “Not Eligible” and “Initial IEP Developed” from being selected at the same event (e.g., meeting).

Step Five: Customizing Business Rules

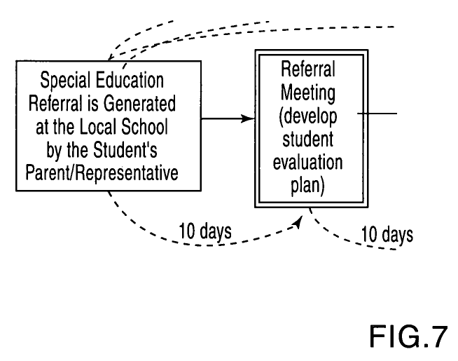

In an embodiment of the present invention, once the event rules are implemented, business rules are customized using the timeline or other guide specific to the management entity. In one embodiment of the present invention, three business rule tables or other repository features are provided that control the rules of the timeline. A first table is the event rules table. As shown in the example timeline portion for an implementation of the system for use with compliance with IDEA requirements presented in FIG. 7, a first event (meeting) says “Special Education Referral is Generated.” This event is connected to the next event, which is a “Referral Meeting,” that occurs within “10 days.”

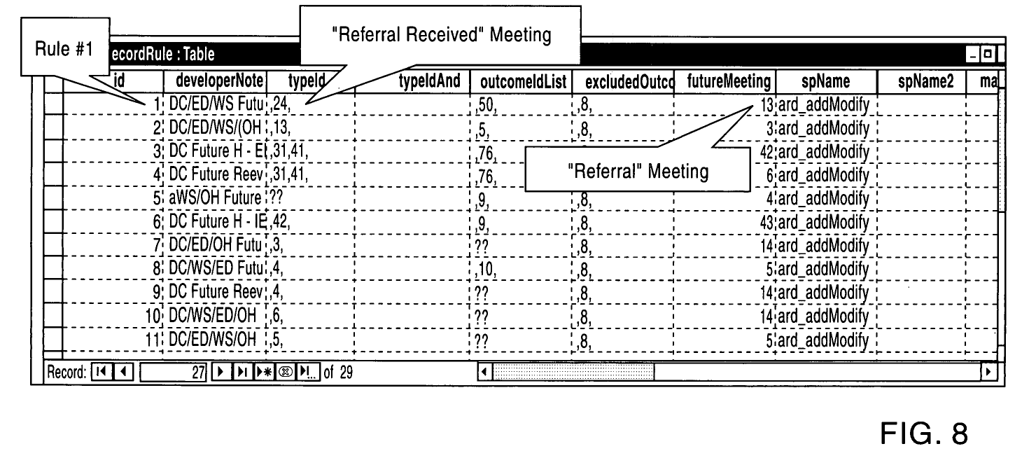

These blocks and arrows in the timeline thus communicate that the “Referral Received” meeting must be followed by a “Referral” meeting within 10 days. This is an example of a business rule that must set up in the business rule table portion of the system. FIG. 8 shows an example business rule table, in accordance with an embodiment of the present invention. As shown in FIG. 8, in the particular example indicated, Rule #1 shows that the meeting “Referral Received” (type #24) will, under the given circumstances, create a “Referral” meeting (#13). Since this rule is required for the management entity in this example, a rule table (for a number of management entities for this particular system) is customized for this rule.

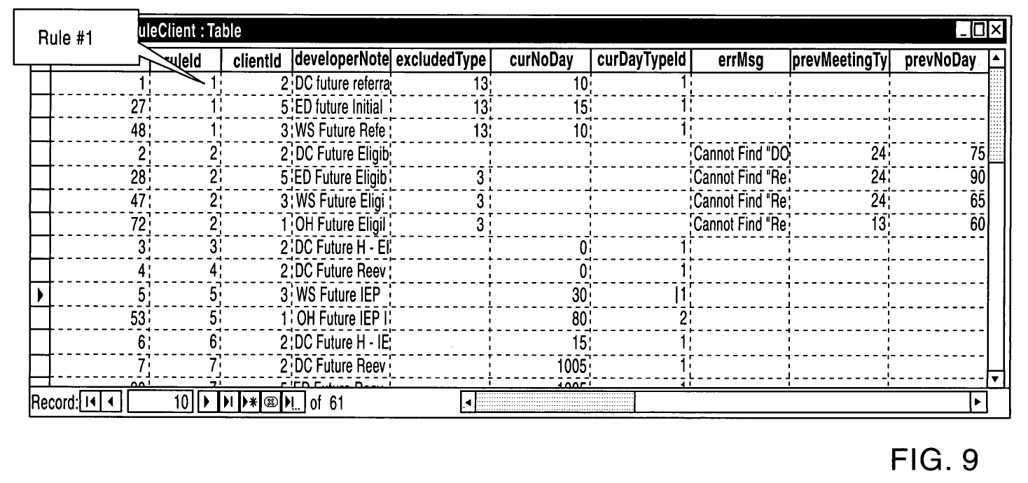

In particular, as shown in FIG. 9, in the rule table, Rule #1 is set up, and “10” is input for the due date, along with any other requirements that apply. In this example, as shown, three management entities are using Rule #1. All other events represented in the timeline that includes the portion shown in FIG. 7 are entered into the rule table or other repository feature in a similar way.

An example application of an embodiment of the present invention for IDEA implementation also includes two sets of additional rule tables that function similarly to those shown in FIGS. 8 and 9. One of these additional rule tables is referred to as an assessment rule table. The assessment rule table controls the timeline for assessments (these are tests given to a student to evaluate needs for special education), and an IEP Rule table, which controls the timeline for an IEP (an Individualized Education Plan required for all special education students). Other implementations of the present invention have similar additional rule tables particular to each implementation. Although all examples provided above relate to rules and configurations relating to the implementation of Special Education/IDEA process management, the same concepts of events, outcomes, timelines, match and no-match rules and the generation of future obligations can be readily applied to any other process relating to an individualized process for implementation of individualized instruction, behavioral or social intervention.

Step Six: Customizing Labels, Buttons, Tabs, and Pick-List Codes

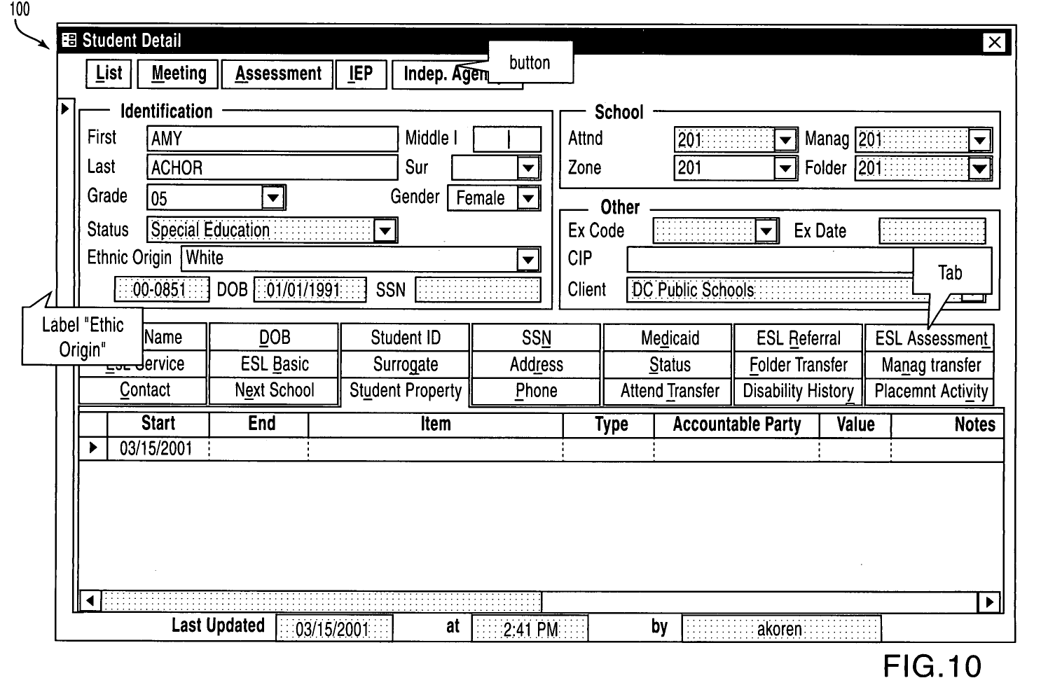

Once the management entity has the required rules entered into the system, additional data options are optionally included for that management entity. For example, each GUI screen, as used in conjunction with some embodiments of the present invention, optionally includes one or more labels, buttons, and tabs, as appropriate, each of which can be customized. For example, one management entity could use the label “Ethnic Origin,” as shown in the Student Detail screen 100 of FIG. 10, while another prefers “Race,” for which the Student Detail screen 100 may be customized to so show.

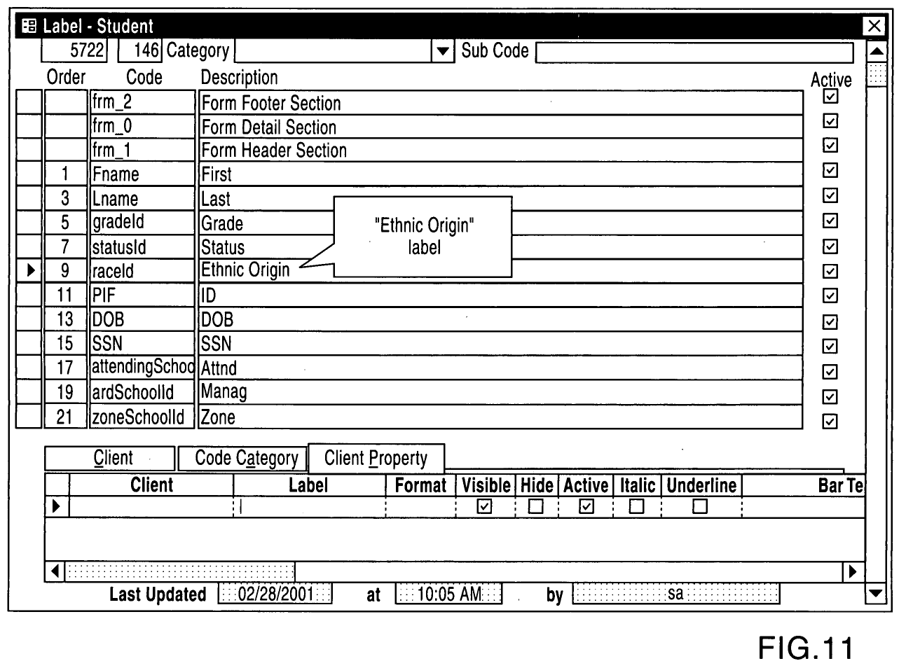

FIG. 11 illustrates a table for allowing customization of labels, buttons, and tabs, in accordance with an embodiment of the present invention. The table of this embodiment enables customization of each label, button and tab on, for example, the Student Detail screen shown in FIG. 10.

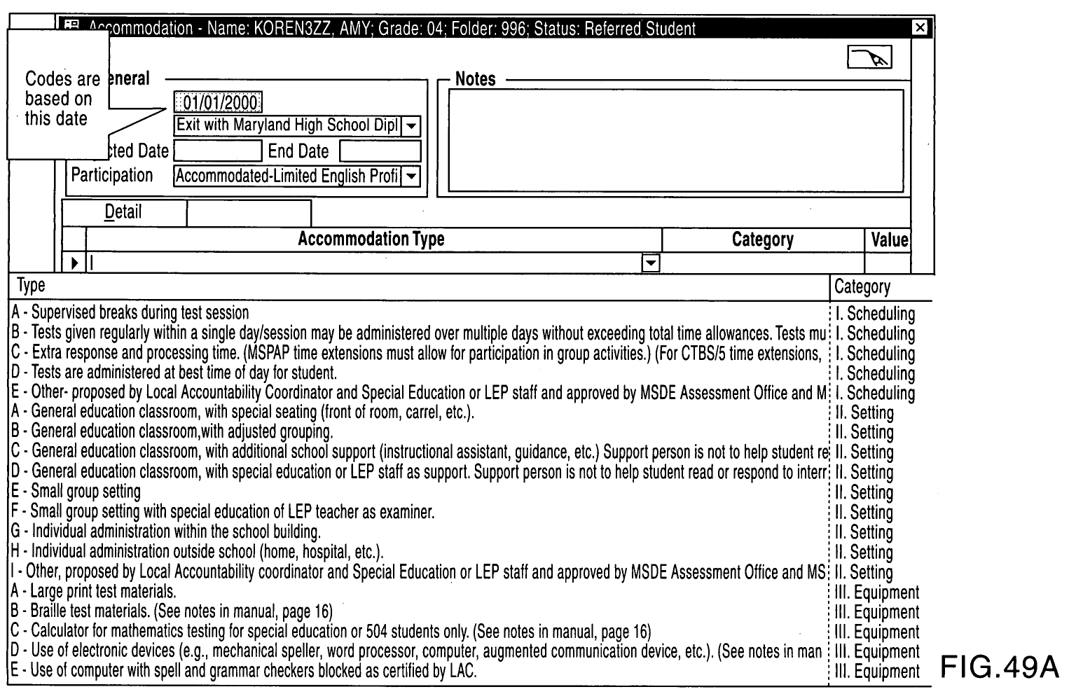

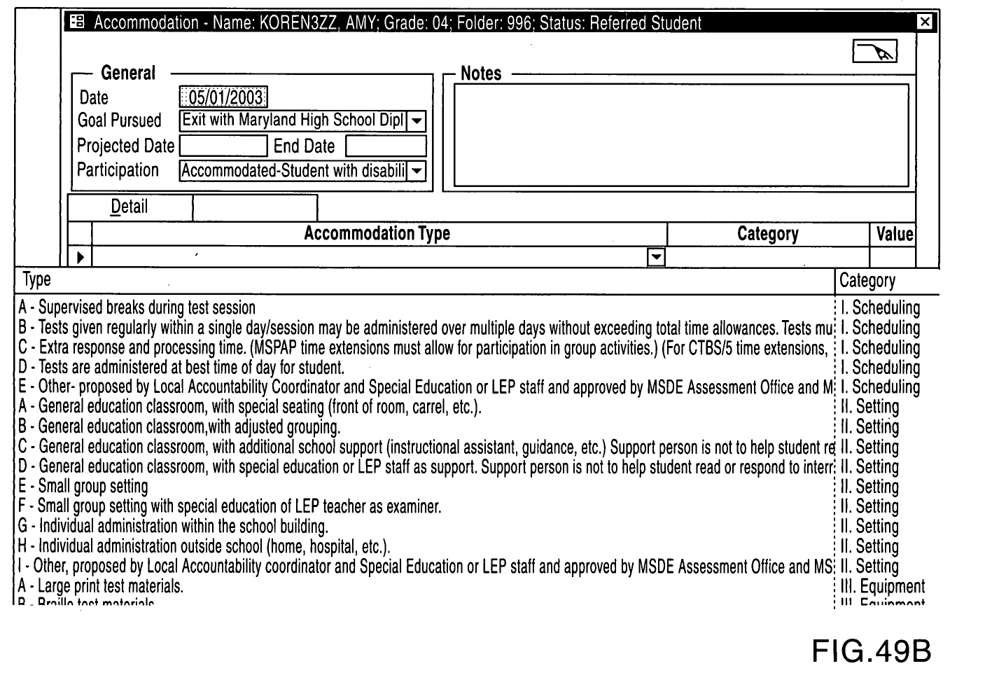

In an embodiment of the present invention, some fields are “free text” fields that allow entry of any letters or words the management entity may prefer. An example of such fields are those for a student's “Name” in the example configured for IDEA compliance. Other fields require a selection from a “Pick-list” of codes. An example of these fields is the student's “Ethnic Origin.” Note that pick-list codes can have a time constraint imposed upon them. A given description may be valid as of one date, but a different description is valid as of a later date. See, e.g., FIGS. 49A and 49B below for an illustration of a change in value for a given code dependent upon a date: the description for the top level code value “C” is significantly shorter as of Jan. 1, 2003 than it is as of Jan. 1, 2000. In addition, a given code value can be valid as of one date but invalid (and therefore not available as a choice) as of another date. A next step in customizing is to provide the management entity with a list of all fields that require a code, and, optionally, to assist the management entity with deciding which codes and what wording they would like to use. For example they could choose “African American” or “Black” or another description of their choice.

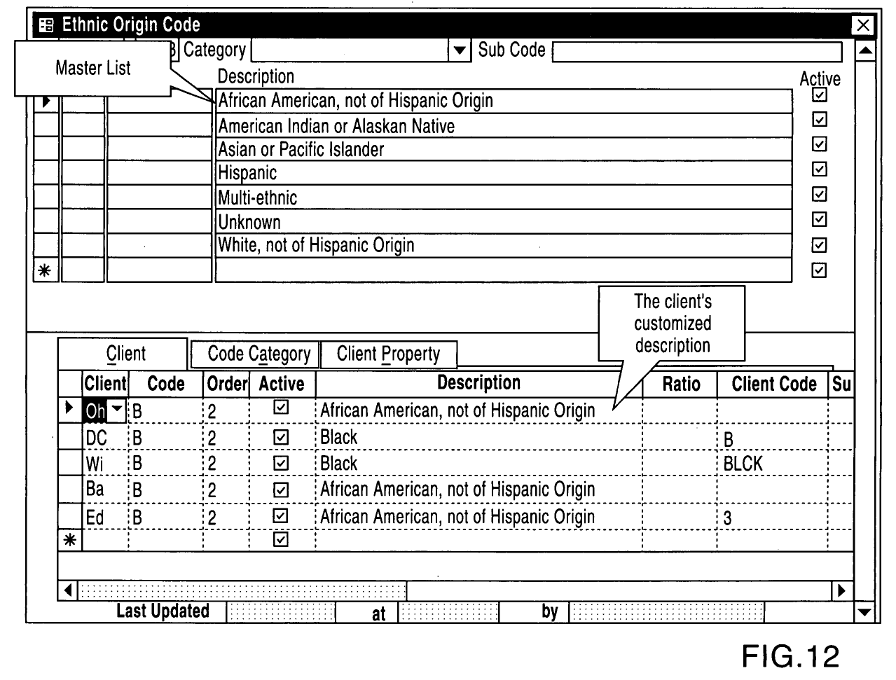

The two-level process described above in conjunction with FIGS. 2-6 is used here as well. First a master list of all codes is provided, which, in the example shown in FIG. 12, includes the “Ethnic Origin” codes. If the management entity prefers a particular code, such as “African American,” this code is entered on the management entity-specific level, and the management entity is able to assign their own description, such as “Black.” If the management entity prefers not to use a code (e.g., for which the selection “Unknown” is provided), no relevant code is provided. If the management entity requires a code not listed, the new code can be added to the master list.

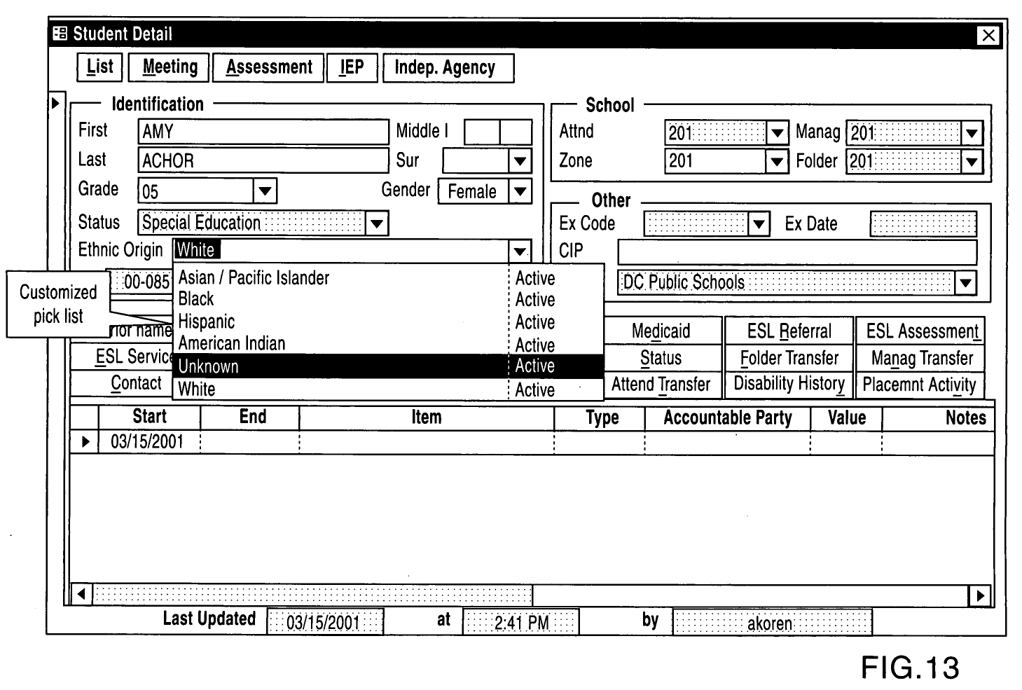

Once all codes are customized, the management entity is able to see their own list with their own wording when they click on the pick list, as shown for the example GUI screen presented in FIG. 13. Again, the advantage to this type of parent - child structure is that the application (both on-line and in reporting) has a constant set of program code underneath it, but a specific management entity sees only its own values. Because the customization is “table-driven” in this manner, rather than dependent upon changes to program logic code, customization can be quickly completed, and there is no impact to other management entities.

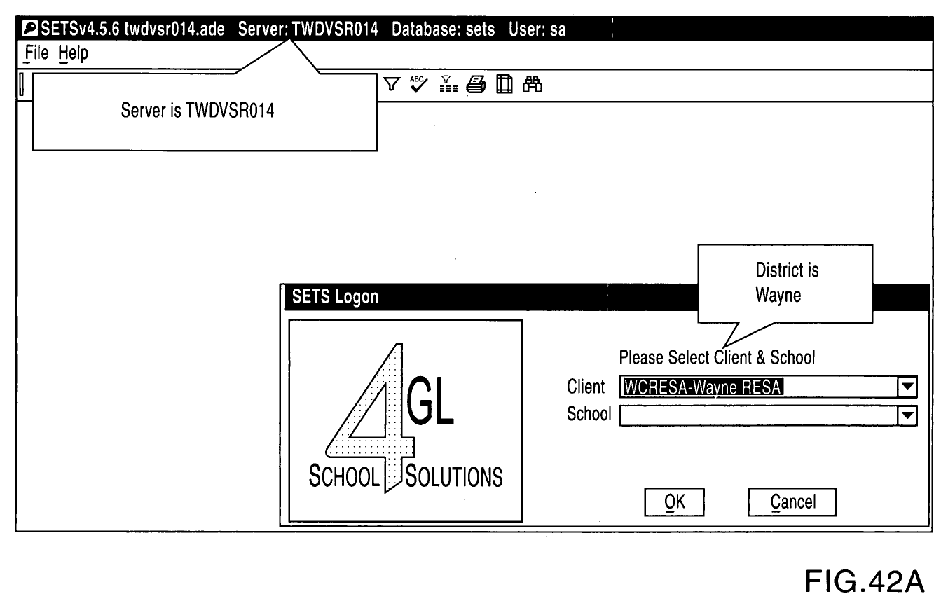

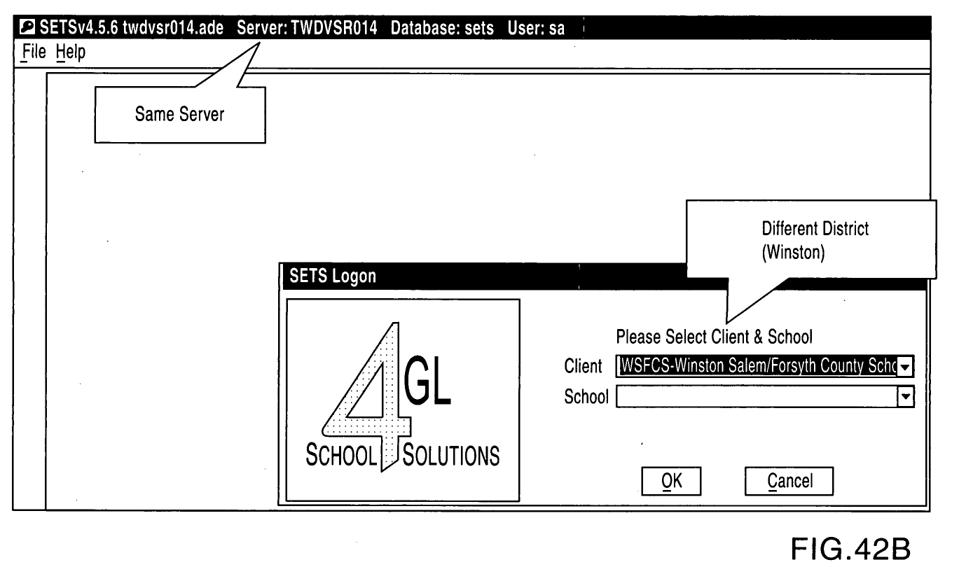

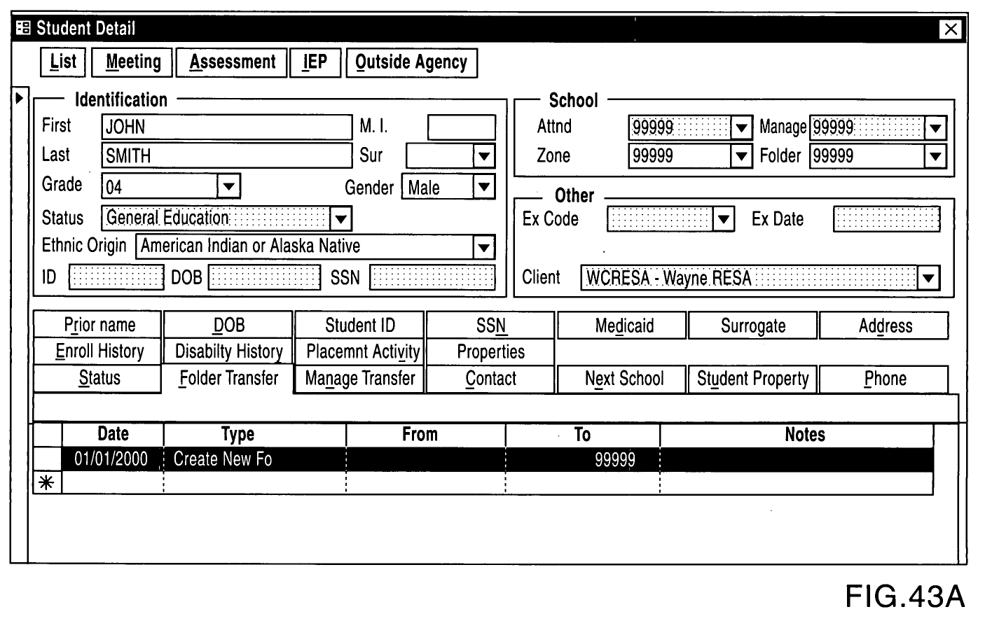

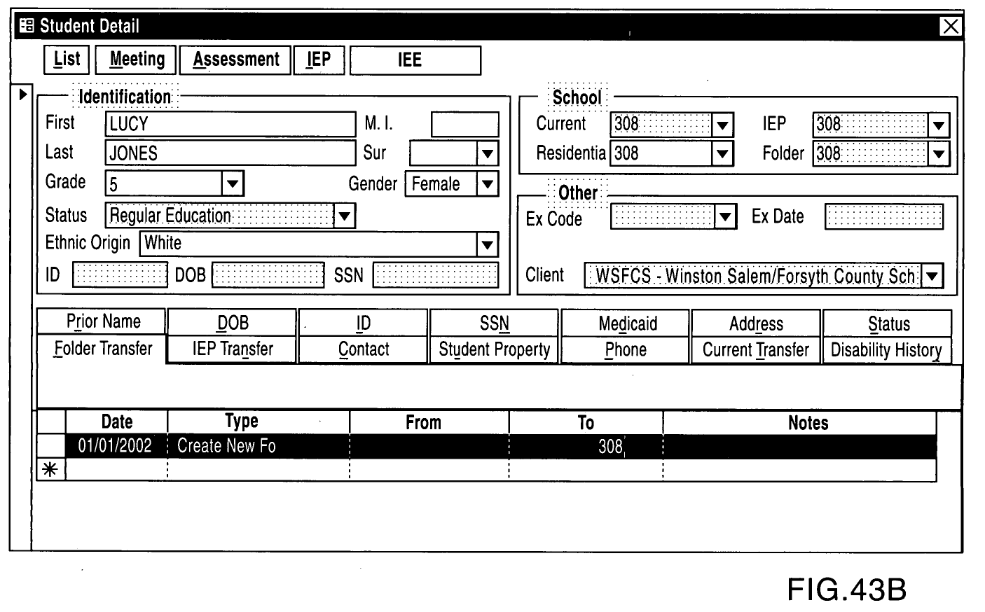

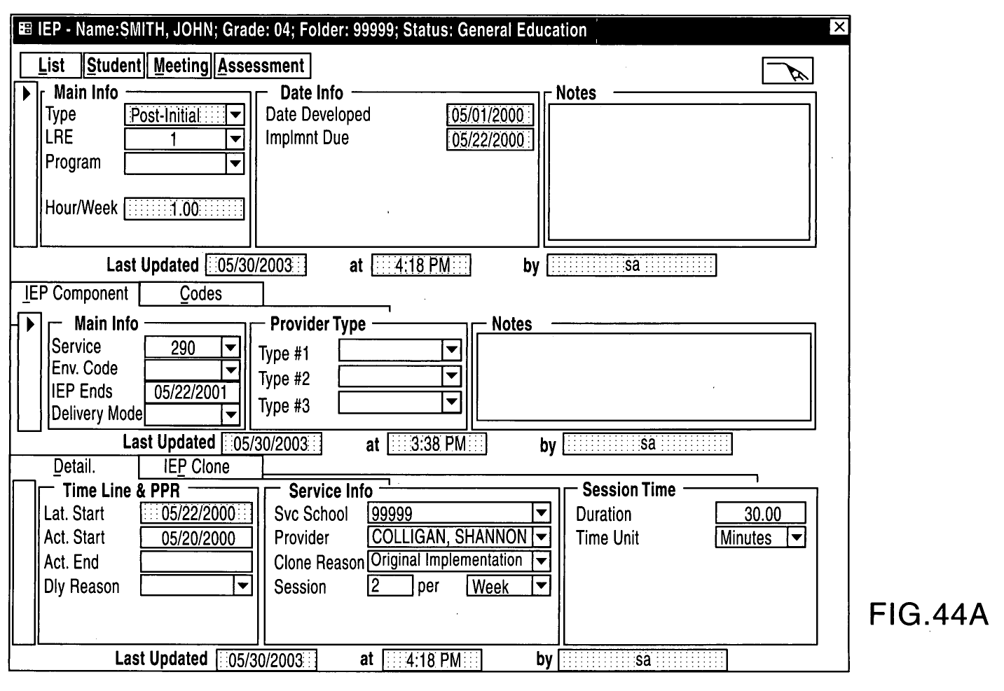

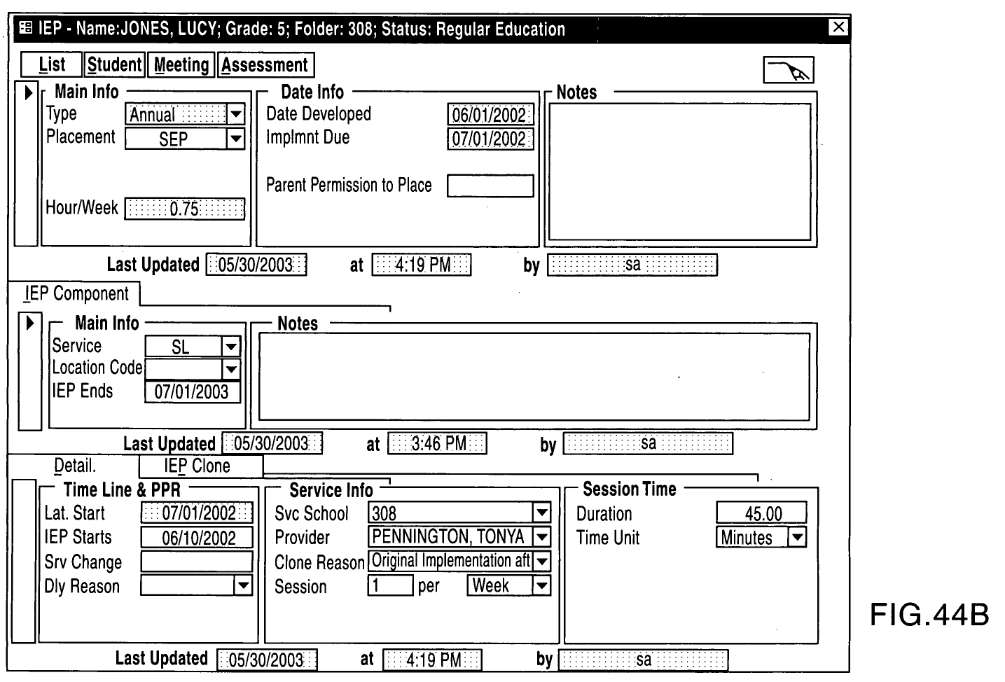

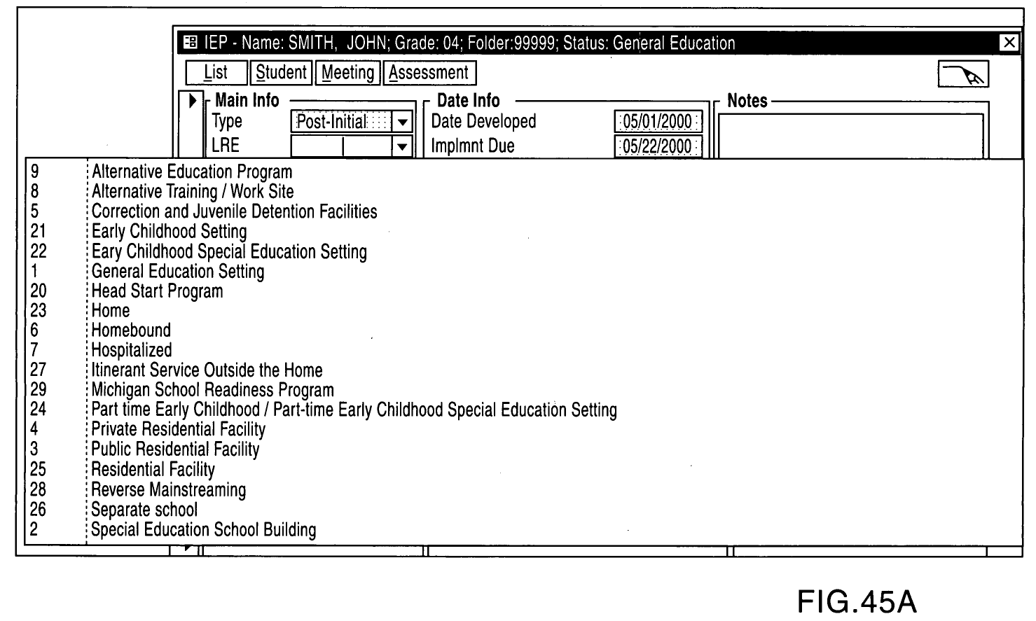

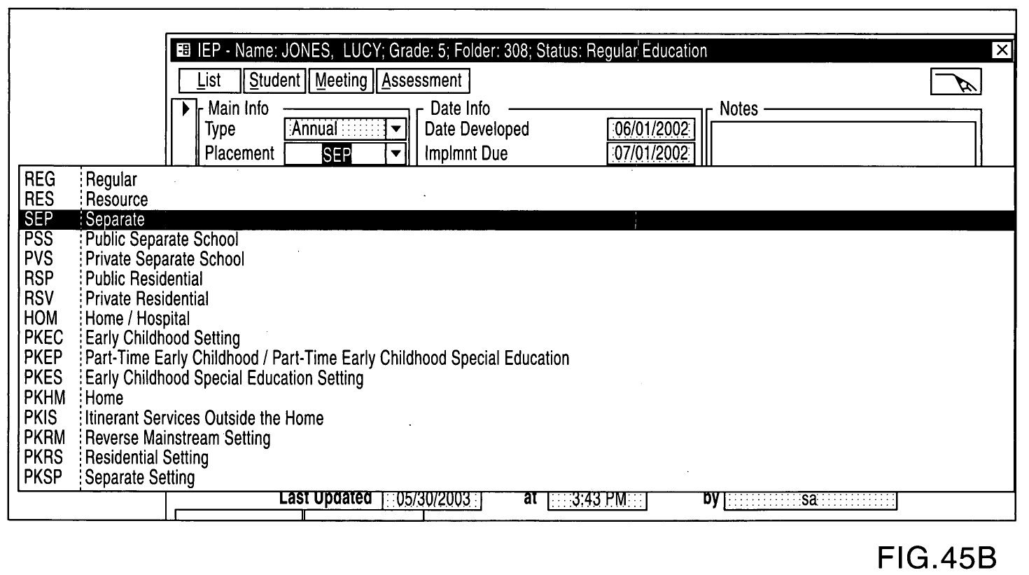

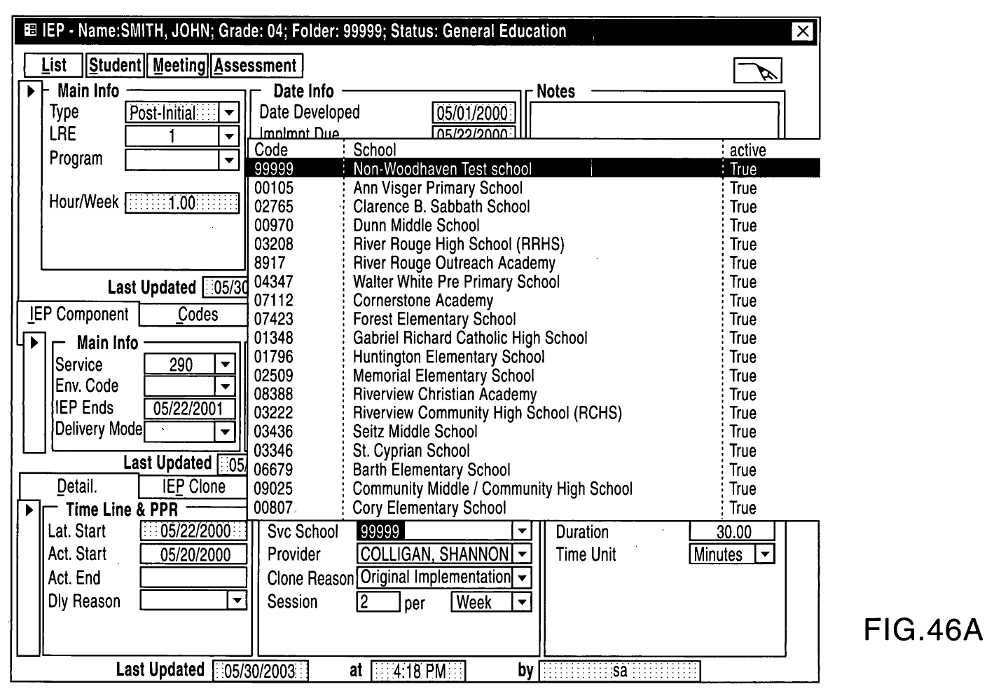

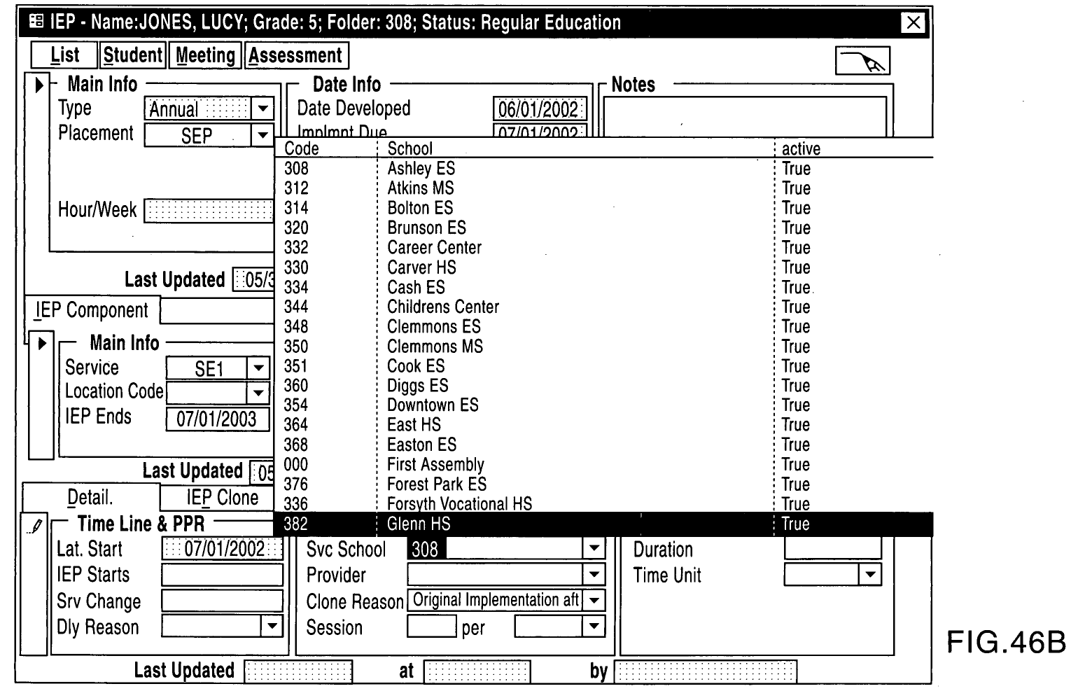

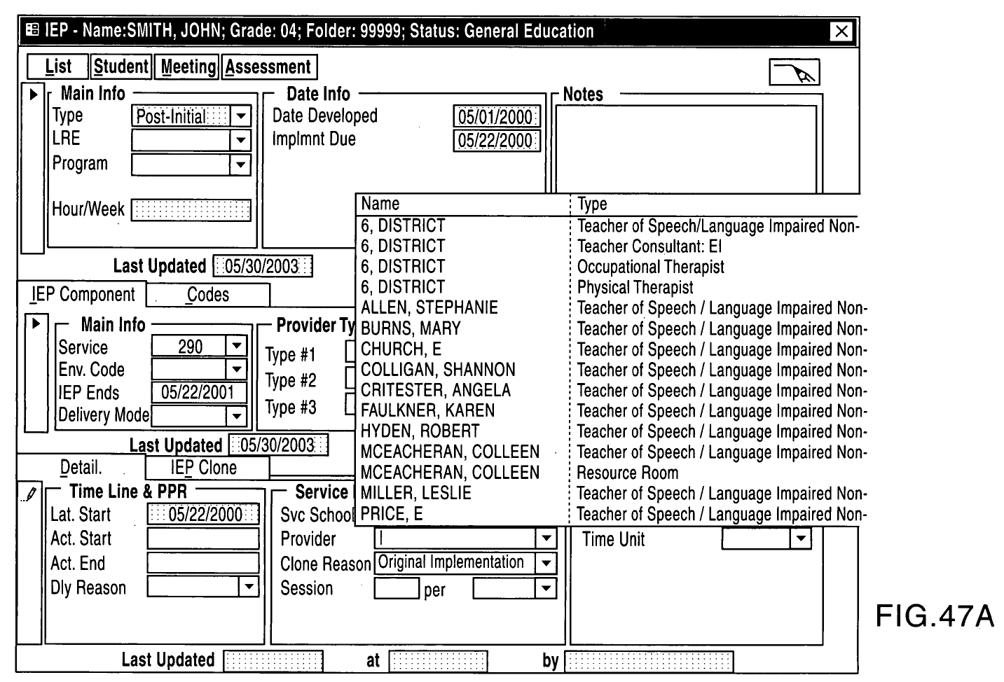

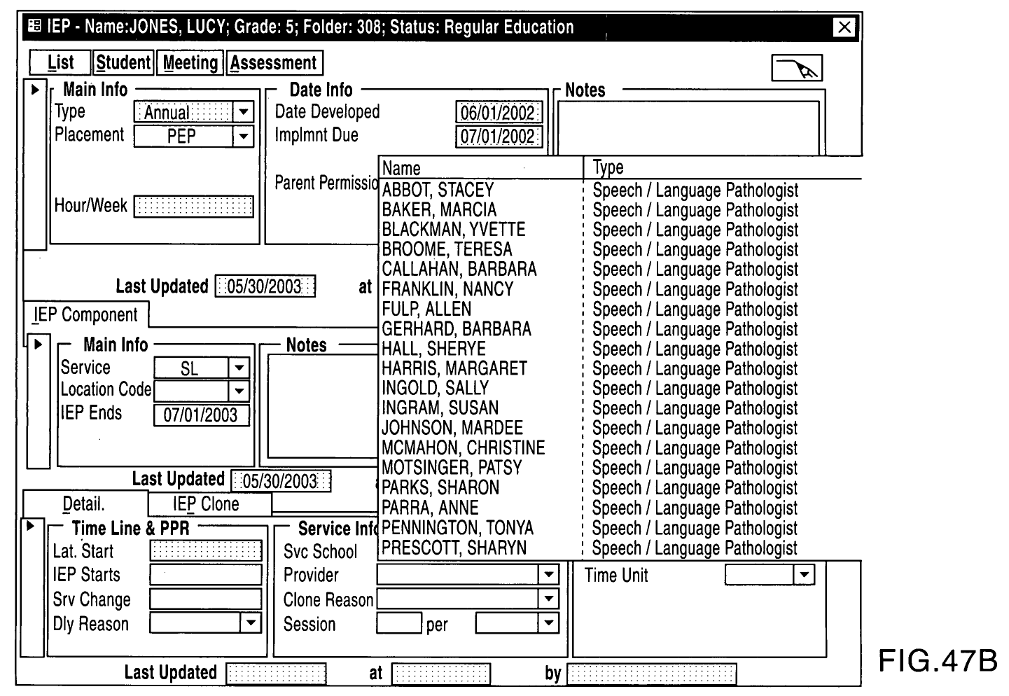

It should be noted that because of the underlying architecture of the system, it is possible for multiple management entities to be represented and configured within the same physical database. When a user assigned to one management entity logs on to the system, the user sees only the management entity information to which they belong (see, e.g., FIGS. 42A and 42B). On the student detail screen, the user is able to view, for example, only those children that belong to their management entity, and the field labels on that screen is customized for their management entity (e.g., in FIG. 43A, the “managing” school is labeled “Manage,” while in FIG. 43B, the same field is labeled “IEP”). On the IEP screen, the same type of label customization is possible, and there is further illustration of the ability to hide or display fields and sections of the screen (see, e.g., FIG. 44A, in which the “Parent Permission to Place” field is hidden; in FIG. 44B, the “Codes” tab in the middle of the screen is hidden). Each client sees their own code values in dropdown boxes. In FIG. 45A, the client has called a field “LRE,” the codes are numeric, and the corresponding descriptions are displayed. In FIG. 45B, the client has called the same field “Placement,” and has' chosen to use alpha codes and a totally separate list of values. FIGS. 46A and 46B illustrate that each client is able to view only its own schools, and that the codes and descriptions are tailored to their specifications. In addition, each client sees only its own providers and provider type descriptions, as illustrated in FIGS. 47A and 47B.

B. Components of System for Compliance with a Management Scheme

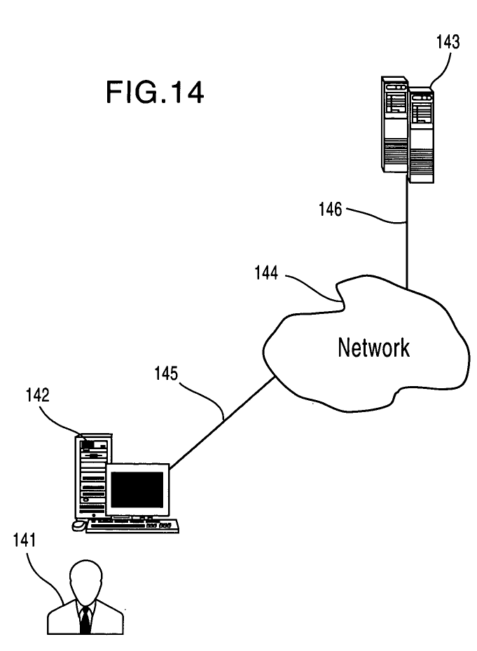

As shown in FIG. 14, in an embodiment of the present invention, some data for use in the system is, for example, input by an accessor 141 (also referred to interchangeably herein as a “user”) via a terminal 142, such as a personal computer (PC), minicomputer, mainframe computer, microcomputer, telephonic device, or wireless device, such as a hand-held wireless device coupled to a server 143, such as a PC, minicomputer, mainframe computer, microcomputer, or other device having a processor and a repository for data and/or connection to a processor and/or repository for data, via, for example, a network 144, such as the Internet or an intranet, and couplings 145, 146. The couplings 145, 146 include, for example, wired, wireless, or fiberoptic links. In another embodiment, the method and system of the present invention operate in a standalone environment, such as on a single terminal.

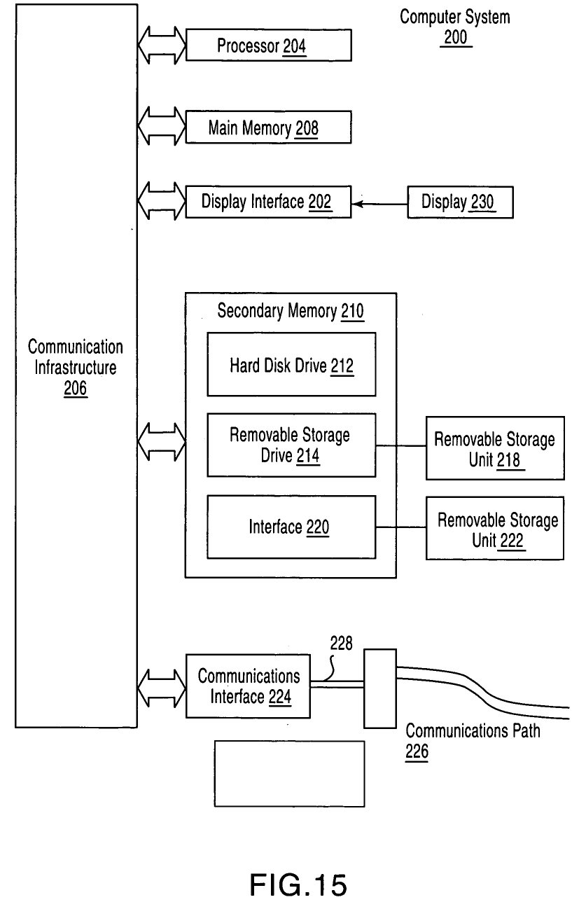

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 15.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modern, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

C. Features of Exemplary GUI Interface for Compliance with Management Scheme

Embodiments of the present invention include one or more GUI screens to assist an accessor with meeting the various requirements of a management scheme. Various features of the GUI screen portion of the present invention will now be described in further detail.

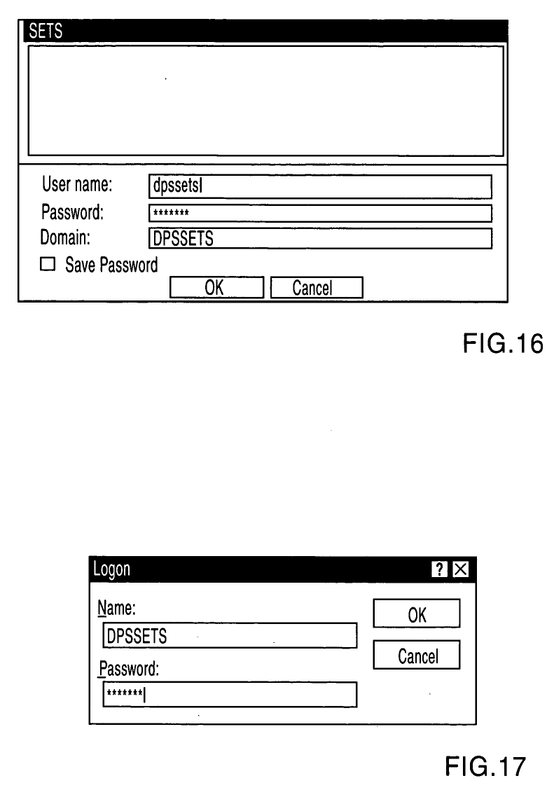

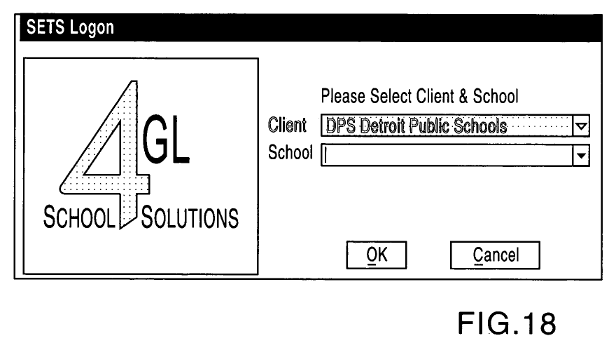

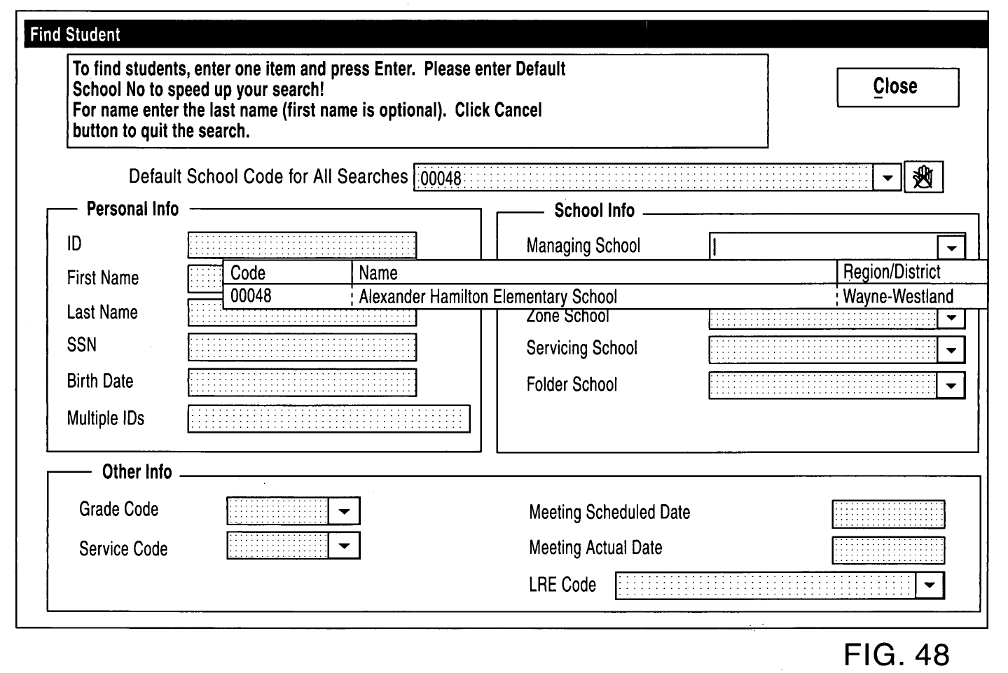

An embodiment of the present invention includes a number of standard features for ensuring security for accessing variations of the present invention for use on networks, such as the Internet or an intranet, or elsewhere, and for confirming individual authorization for access of the system. In addition, such security can be used to vary the accessor's access to various portions of the system (e.g., one level of accessor may input information, but not change preset requirements; another level of accessor may also vary system requirements and generate reports). FIG. 16 shows an example network access GUI interface, and FIG. 17 presents an individual user login GUI interface, in accordance with embodiments of the present invention. FIG. 48, below, illustrates an example of the limitation of a user's access based on the school to which the user is assigned In an embodiment of the present invention, following login or other appropriate security authorization, the system accessor is presented with the appropriate management entity information and customization specific identification confirmation. For example, as shown in FIG. 18, a specific customization and management entity selection confirmation is presented for a particular school district and school, for an IDEA implementation of the present invention.

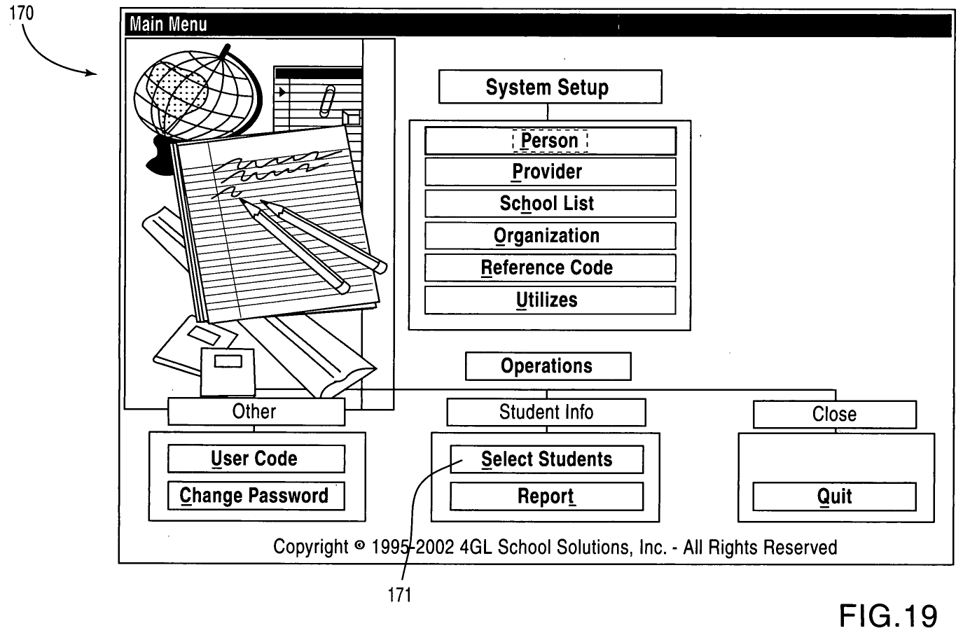

Following identification of the customized management entity, a series of options for obtaining information is provided to the accessor. For example, as shown in FIG. 19, in one embodiment, a variety of levels of interaction are made available to the accessor via an initial GUI screen 170, with the level of access varying depending on the accessor's level (e.g., only supervisors have system setup access functions).

Various self-explanatory options are available via the initial GUI screen 170, including accessing various system setup functions, including persons, providers, school lists, organizations, reference codes, and utilities; and operations, such as user codes and passwords, student information, including student selection and reports, and system exit functions. As discussed above, in one embodiment, the accessor's capability to access certain functions (e.g., system setup functions) can be limited via the security portion of the system.

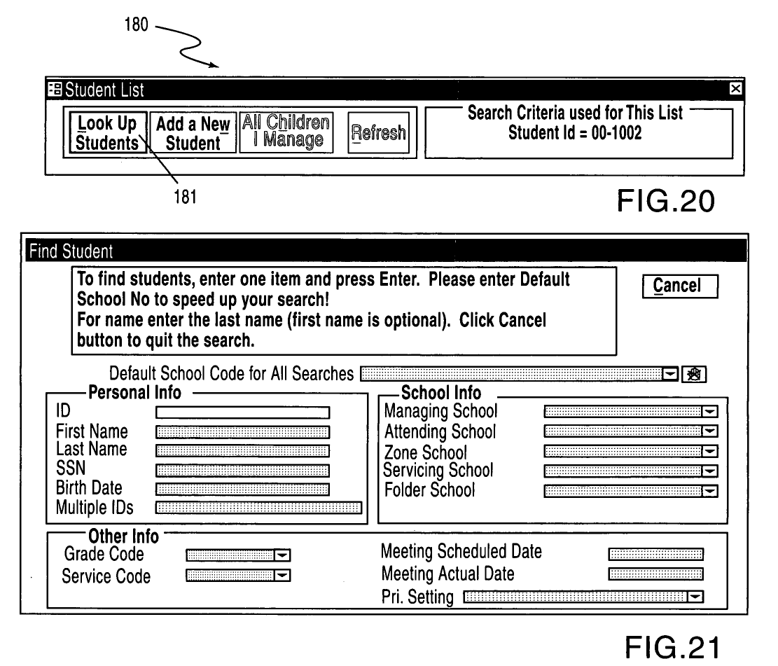

A series of exemplary access events will now be discussed in more detail, in accordance with an IDEA implementation of the present invention. In FIG. 19, in order to access student specific information, the accessor first selects the “Select Students” button 171. The accessor is then provided with several selection options, such as via a GUI screen 180 (e.g., a pop-up menu), as shown in FIG. 20.

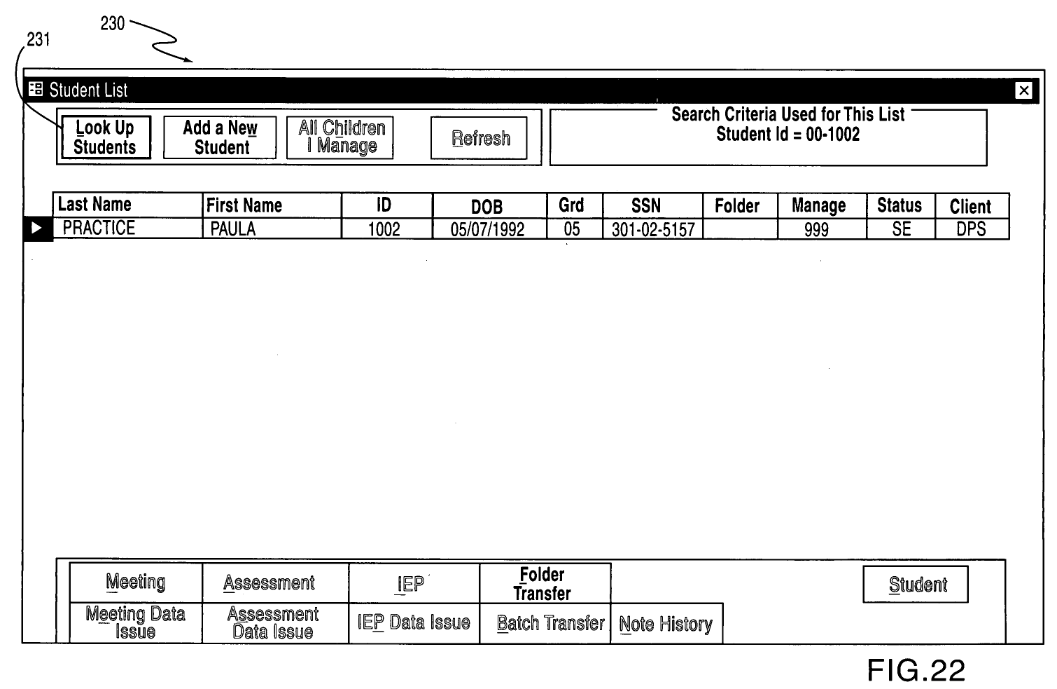

The accessor then selects the “Look up Students” button 181. In this example, the Find Student Screen then appears, as shown in FIG. 21, which offers several different options for searching for a student. In this example, a student may be searched via any of the following: 1) First Name/Last Name; 2) Date of Birth; 3) Social Security Number; 4) Student ID; or 5) Managing School. To complete the search for the student in this example, the accessor then provides other appropriate information and takes other relevant actions, as necessary. For example, the accessor may 1) Select the Last Name Field; 2) Inputs a name (e.g., “Smith”) and select <ENTER>; and 3) Review the Student Search Result List, as shown in the example GUI screen 230 presented in FIG. 22. To begin a new student search, with this implementation, the accessor takes the following actions: 1) selects the “Look up Students” button 231; 2) Selects the Student ID field; 3) Inputs the ID number for a student, and selects <ENTER>; and 4) reviews a shorter Student Search Result List.

In one embodiment, if a search problem arises (e.g., student is not found in this example), the search results screen comes up empty. It is then possible for the accessor to return to the search criteria screen and enter different criteria.

Various additional features of the particular implementation directed to IDEA compliance as shown in FIG. 22 and those following, will now be described in further detail.

Folder Transfer - this function is performed to indicate that a school has received or given up responsibility for maintaining a student's records for a particular process, such as Special Ed. The creation, receipt or request for a folder for a school indicates that that school now has the responsibility for maintaining the student's paper and electronic records. Once the Folder Transfer is complete, the school can view and modify a student's record. Folder Transfers are required for students entering a school district, as well as students who change schools within the school system. Note that in this example, if all the buttons on the bottom of the screen are gray except for the Folder Transfer button, a folder transfer must be completed before the record and meeting information can be viewed for a student.

Creating a Folder for a New Student. A folder for a new student is created from the example screen shown in FIG. 22 by performing the following actions:

1. Selecting the Folder Transfer button at the bottom of the Student List Screen shown in FIG. 22; and

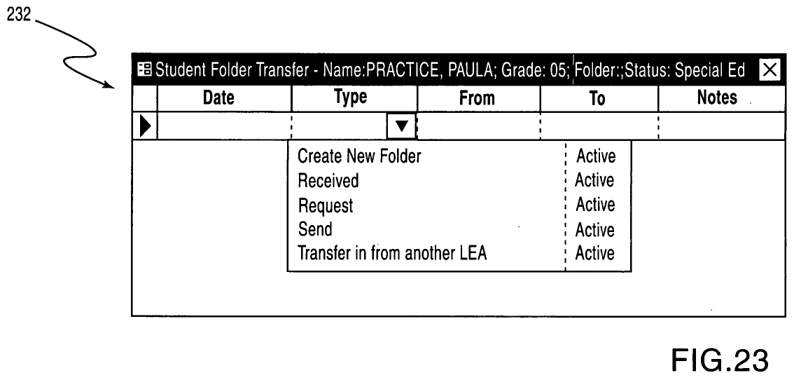

2. In the Date field of the screen 232 of FIG. 23, which then appears, the date the student was either referred to special education or the date a special education folder was requested or received by the school is input. If a student is new to a district but has been in Special Ed previously, for example, it is possible to enter old meeting and IEP information and generate the appropriate future meetings and obligations once the folder school has been properly set.

3. In one embodiment of this example, there are five “Type” options for a Special Education Student Folder Transfer, as shown in the screen 232 presented in FIG. 23. The option that pertains to a Special Education Student's situation is selected from the following: 1) Create New Folder; 2) Received; 3) Request; 4) Send; and 5) Transfer in from another LEA. For example, for a new special education student entering the school district, “Create New Folder” should be selected.

4. For this example, the down arrow in the Type field is selected, followed by Create New Folder.

5. The down arrow is then selected in the “To” field, and the appropriate school code is selected.

6. The Save Pencil to the left of the record is selected or other save option is used.

7. The (X) in the upper right corner of the window is then selected or other close option used, to return to the Student List screen.

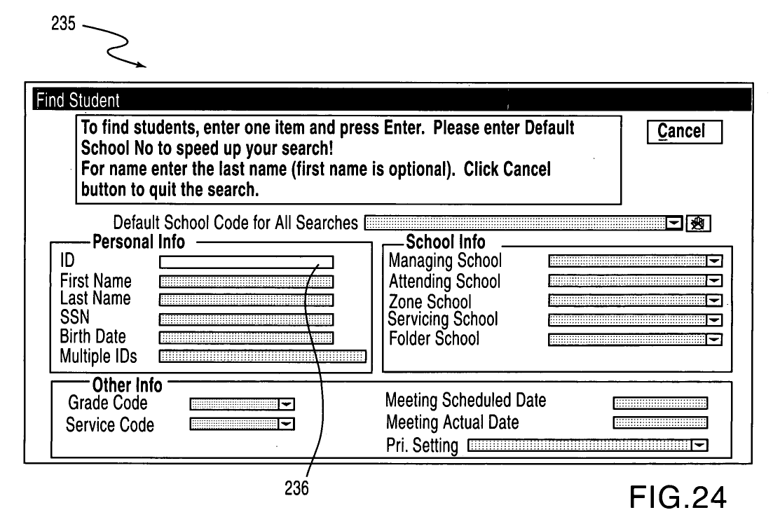

Completing a folder transfer for a student within the district who is changing schools using the above example configuration for IDEA implementation will now be described in conjunction with FIGS. 24-27:

1. Beginning with, for example, FIG. 22, the Look up Students button 231 in upper left corner of the Student List screen 230 is selected.

2. The ID number for the Student is input in box 236 on the Find Student Screen 235, as shown in FIG. 24.

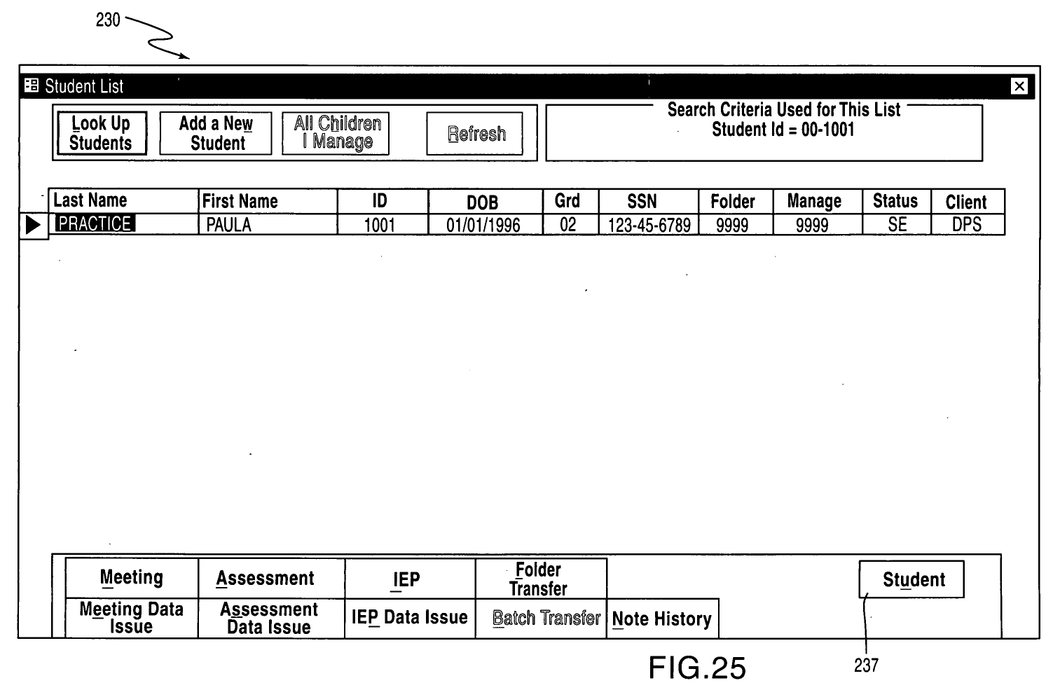

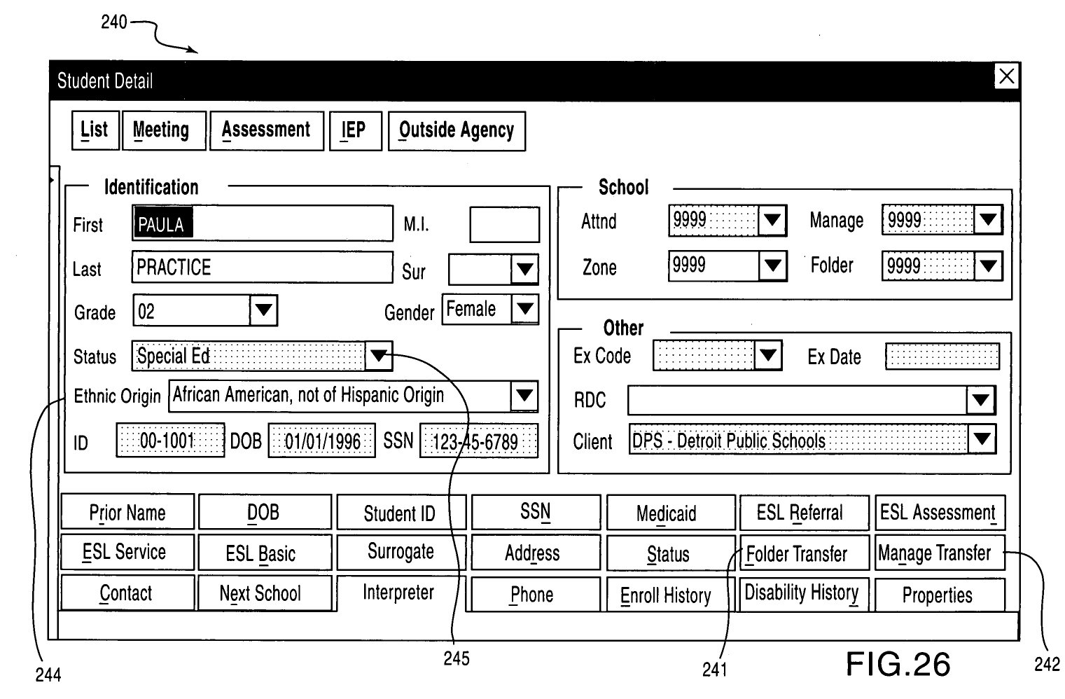

3. The Student button 237 in the bottom right corner of the Student List Screen 230 is then selected, as shown in FIG. 25. This activates the Student Detail Screen 240, as shown in FIG. 26.

4. On the Student Detail Screen 240, the Folder Transfer tab 241 is selected, as shown in FIG. 26.

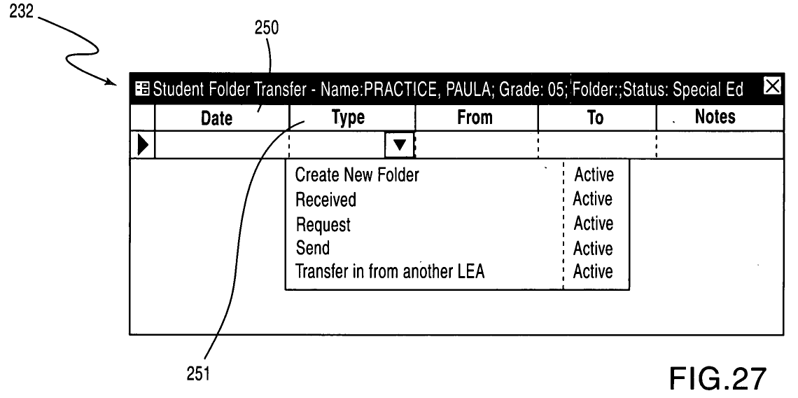

5. As shown in FIG. 27, which presents the Student Folder Transfer Screen 232, in the blank Date field 250, the date the special education Folder is received from another district's school is entered.

6. The down arrow in the Type field 251 is selected, and then “Received” or other transfer type that applies to the Folder Transfer is chosen.

7. The down arrow in the From field and the school the student is transferring from are then selected, along with the school the student is transferring to.

8. The Save Pencil to the left of the record or other save mechanism is used to save the record. The Folder Field at the top of the Student Detail Screen presents relevant information to saving.

9. Selecting the (X) in the upper right corner of the window returns the accessor to the Student List screen, as shown, for example, in FIG. 22.

Note that, as previously discussed with regard to FIGS. 3-12, embodiments of the present invention allow various features of the GUI screens, as shown, for example, in FIG. 26 to be varied with customization for each management entity. For example, the label Ethnic Origin 244 can be changed based on a management entity preference to, for example, “Race,” and the names of the various items in the dropdown menu accessed by down arrow 245 can also be renamed, or different items included, depending on management entity selection. Using the tables and functions described in conjunction with FIGS. 3-12, such customized variations appear automatically for each management entity.

Procedures relating to making a transfer of the student, for the example embodiment of the present invention relating to IDEA implementation, will now be described.

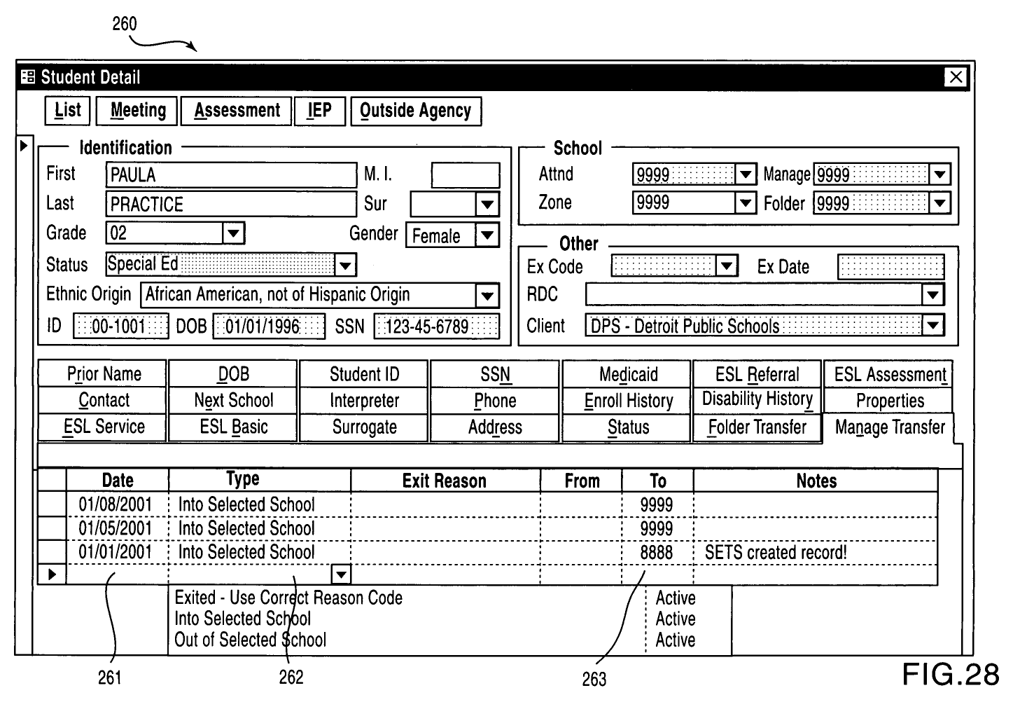

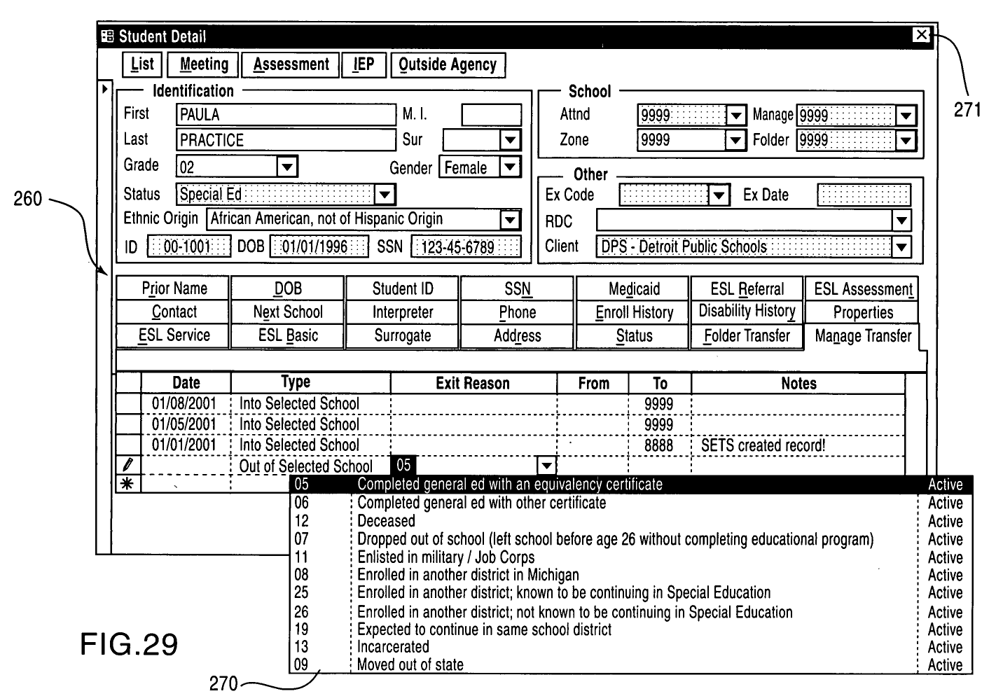

In accordance with one embodiment, one type of transfer relating to IDEA implementation, referred to as a “Manage Transfer,” is required if an existing special education student transfers to a different school or if a different school within the district is managing the student's special education requirements. Performing a Manage Transfer in this embodiment will now be illustrated in conjunction with FIGS. 28-30:

1. From, for example, FIG. 26, the Manage Transfer button 242 is selected.

2. A Student Detail screen 260, as shown in FIG. 28, then appears. In the blank Date field 261, the date the student transferred into the school is input.

3. The down arrow in the Type field 262 is then picked, and Into Selected School is selected.

4. As shown in FIG. 28, the To field 263 and the school the student is entering. Note that an additional field can be completed at the time a student transfers out. If the type of “Exit” is selected, an “Exit Reason” can be entered.

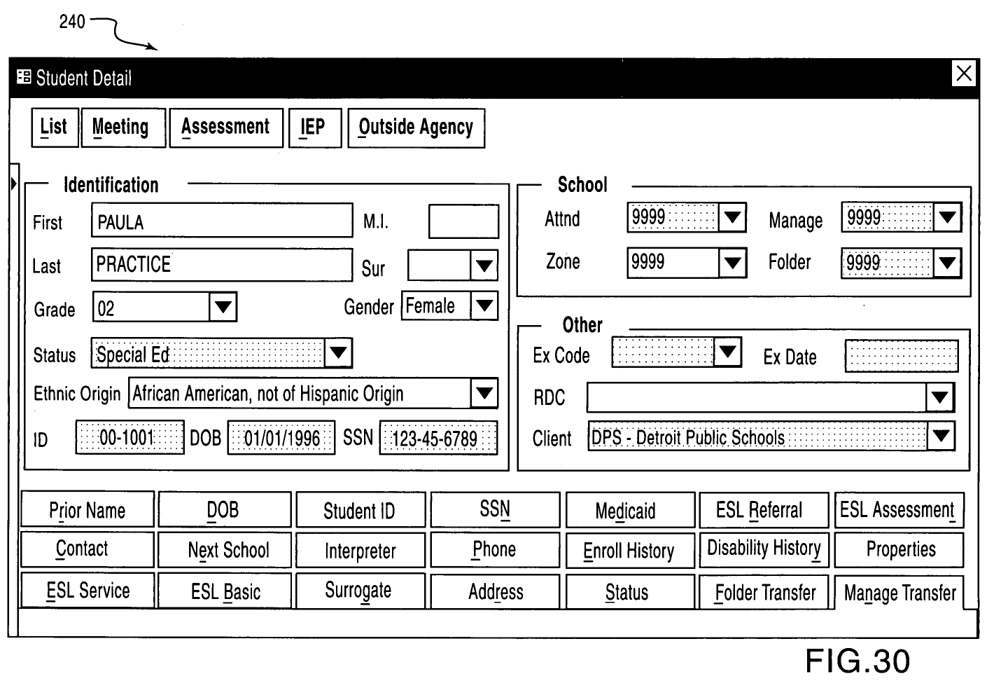

5. The Save Pencil to the left of the record may be used to save, and the (X) 271 in the upper right-hand corner is used to close the screen 260. Note that information shown in the Student Detail screen 240, as shown, for example, in FIG. 30, will then reflect the changed information.

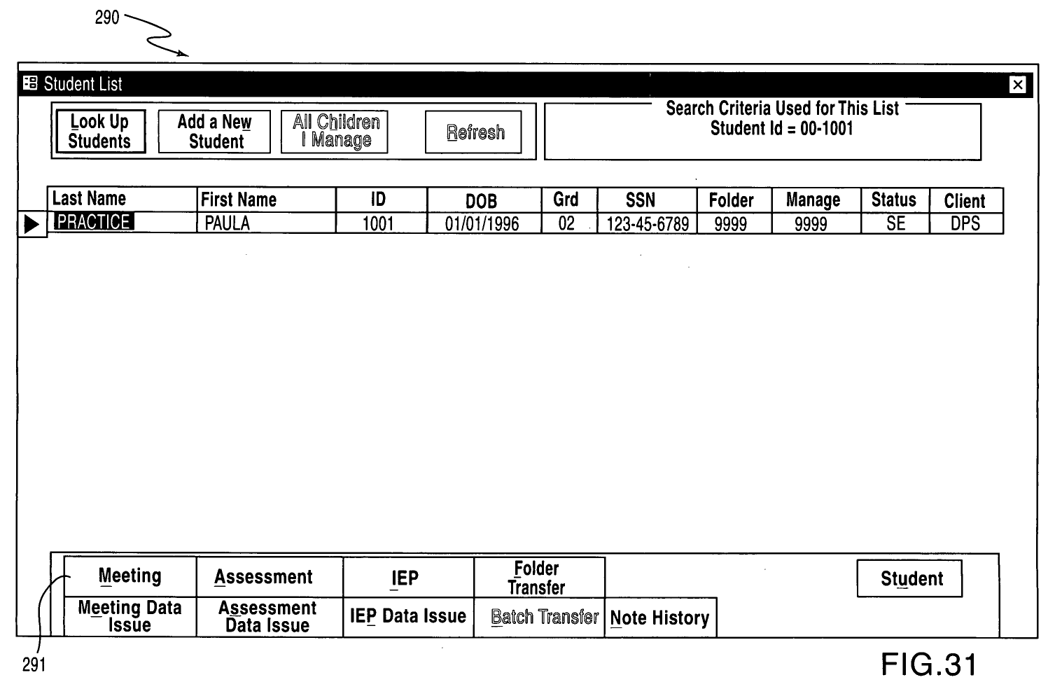

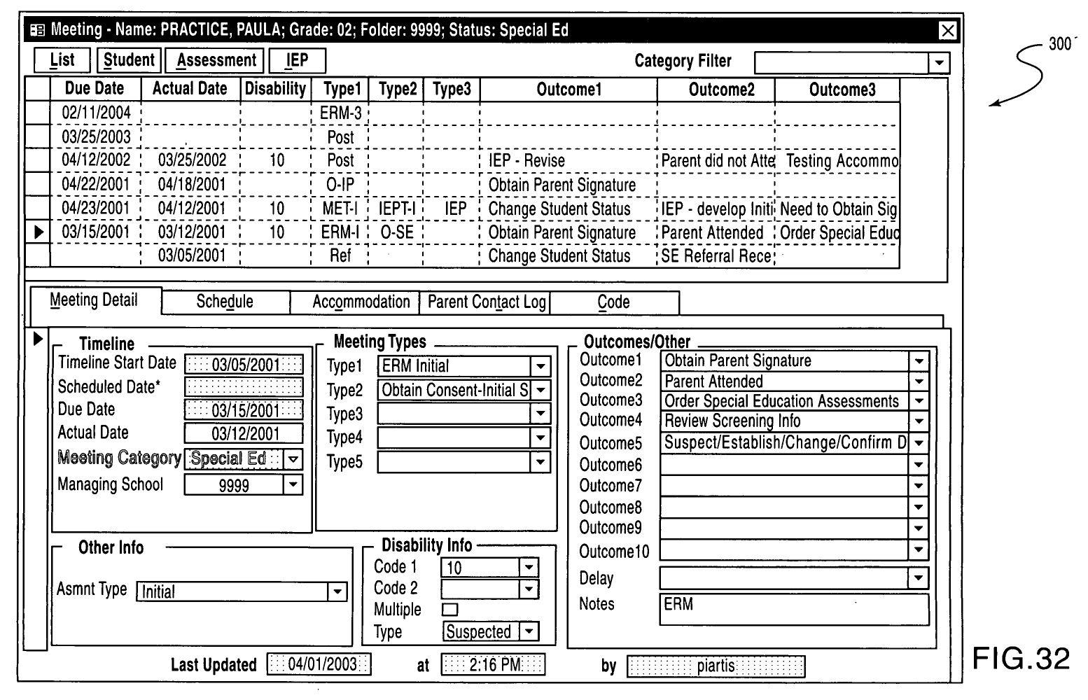

Procedures relating to viewing student meeting types and outcome, for the example embodiment of the present invention relating to IDEA implementation will now be described, in conjunction with FIGS. 31 and 32:

1. The Meeting button 291 on the Student List Screen 290, as shown in FIG. 31, is selected.

2. The Meeting Detail Screen 300 then displays the various information, as shown in FIG. 32. This information can include, for example, the following: 1) Student Name; 2) School Information; 3) Recorded Meeting Types and Outcomes; 4) Assessment Types; 5) Students Status; 6) Disability Information; and 7) Special Ed Referral Source.

Note that, in the example embodiment shown in FIG. 32, the system automatically generates future meeting dates that fall within federally mandated timelines or that are otherwise selected by the management entity, and the system iteratively requires completion of data input for additional events, or other requirements, as appropriate. For example, the completion of a meeting may necessitate a follow up by a certain date and input of indication of completion of pa perwork requirements by a certain date. In some embodiments, the accessor is required to complete each requirement, which, in turn, generates additional requirements, until features of the management entity customized application of the timeline are completed for the subject entity (e.g., student).

Note also that other features may also be customized and otherwise cross referenced via the various screens, such as the Meeting Screen 300. For example, if additional management schemes are applied to a subject entity (e.g., a student), these additional management schemes could be accessed via, for example, buttons or pulldown menus on the Meeting Screen 300. Thus, for example, if the student to whom the Meeting Screen 300 applies were also subject to requirements under section 504 (having conditions significantly impacting quality of life, such as diabetes or requiring wheel chair access) or for whom an intervention (an interaction (e.g., tutoring) with the student to address student problems so as to attempt to prevent placement of the student within a special education program or to provide other services falling outside of special education) is involved, or for whom disciplinary requirements apply, various events and outcomes relating to these requirements for this student could be accessed via a pulldown menu or other feature added, for example, to the Meeting Screen 300. The present invention includes the capability to support overlap of multiple timelines simultaneously across management schemes. Not only can multiple timelines be in place at the same time, but one management scheme can generate obligations in another management scheme. For example, the finding of a child to be not eligible in the Special Ed management scheme could generate a “Referral for 504” in the 504 management scheme. Each management scheme timeline and each interaction between management schemes can be configured for a district's own rules.

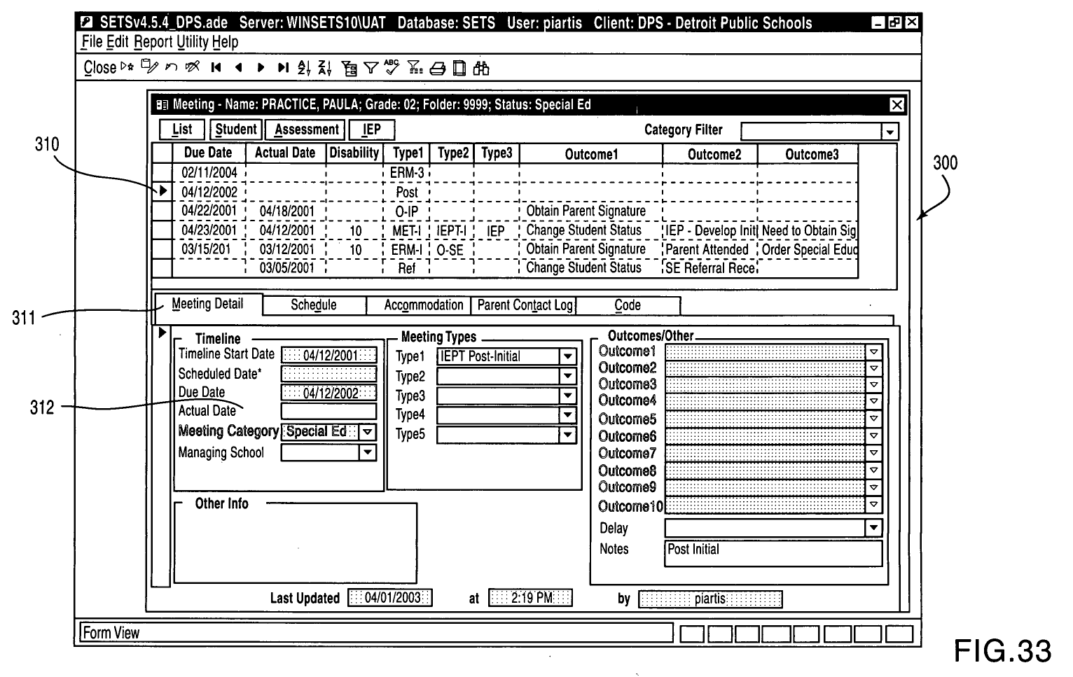

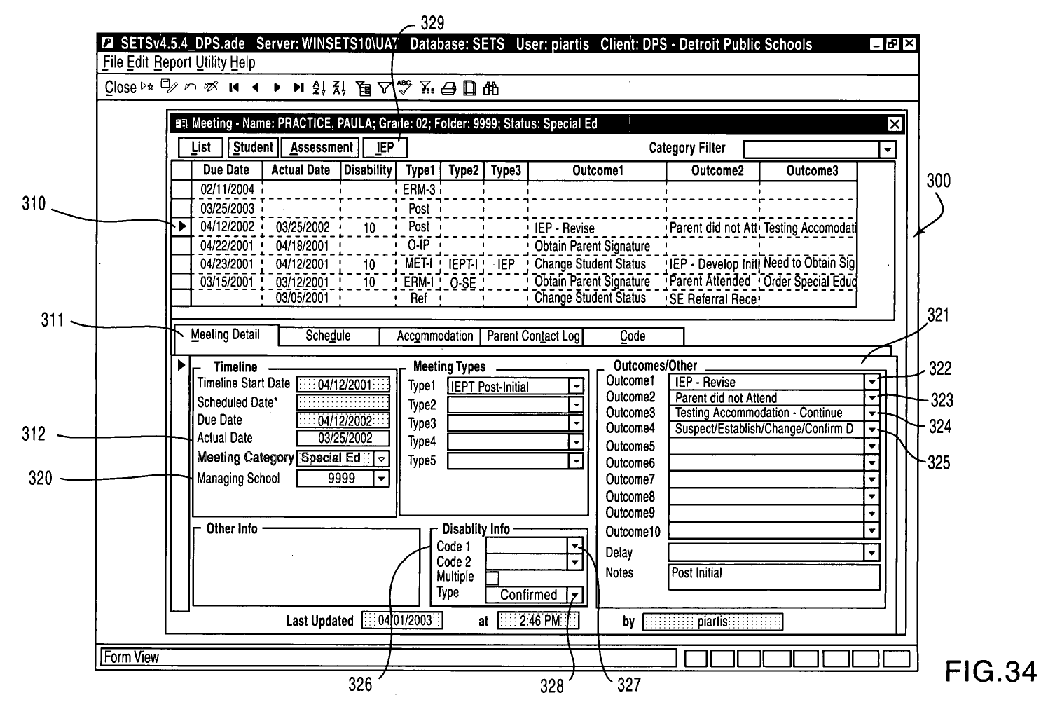

Features and procedures relating to post initial activities for students, for the example embodiment of the present invention relating to IDEA implementation will now be described, in conjunction with FIGS. 33 and 34.

Post-Initial—For use in the exemplary embodiment shown in FIGS. 33 and 34, according to federal and state guidelines, an IEP must be reviewed annually, one (1) year from its original date, and may be reviewed at any time upon written request from the child's parent/guardian, teacher, or other school district professionals. To record a postinitial meeting event, as shown in FIG. 33, the following actions are taken:

1. From the top of the Meeting screen 300, the line for the Post Initial Meeting 310 is selected or input. This action activates the Meeting Detail 311 at the bottom of the screen 300 for this meeting.

2. From the bottom section on the Meeting Detail tab 311, the Actual Date field 312 is selected.

3. A date, such as Mar. 25, 2002 is input in the Actual Date field 312, as shown in FIG. 34.

4. In the Managing School field 320, a school identifier is entered, such as 9999. The Outcomes/Other field 321 then becomes available for additional input, as appropriate

5. The down arrow 322 is used for inputting Outcome 1, and, in this example, IEP Revise is selected, the down arrow 323 is also used for Outcome 2, in which, in this case, the selection made is Parent Did Not Attend. The down arrow 324 is used for Outcome 3, for which Testing Accommodation - Continue is selected, and the down arrow 325 is used for Outcome 4, for which Suspect/Establish/Confirm Disability is selected.

6. In the Disability Info section 326, the down arrow 327 is used to input Code 1, such as the selected value 10.

7. The down arrow 328 for Type is used to select a type, such as Confirmed.

8. The input information is then saved, such as by using a Save Pencil to the left of the Meeting Detail tab 311.

Note that in one embodiment, the outcomes presented can iteratively vary depending on inputs of previously inputted information. Thus, for example, if one meeting type is selected, only certain outcomes can be selected, and additional meeting selections may be required, with corresponding outcomes to be selected. As described above with regard to FIGS. 3-12, the chain of events and outcomes that can require iterative input and that causes variation of selectable options for the accessor depends on the previously customized timelines and corresponding requirements and other features selected for a particular management entity.

In addition, in some embodiments of the present invention popup screen or other features are used to prompt the accessor or to otherwise indicate input needs or problems. For example, if a particular event type is selected for a subject entity (e.g., student) that cannot be selected under the timeline as previously completed, a popup screen appears indicating that an error or potential error has occurred.

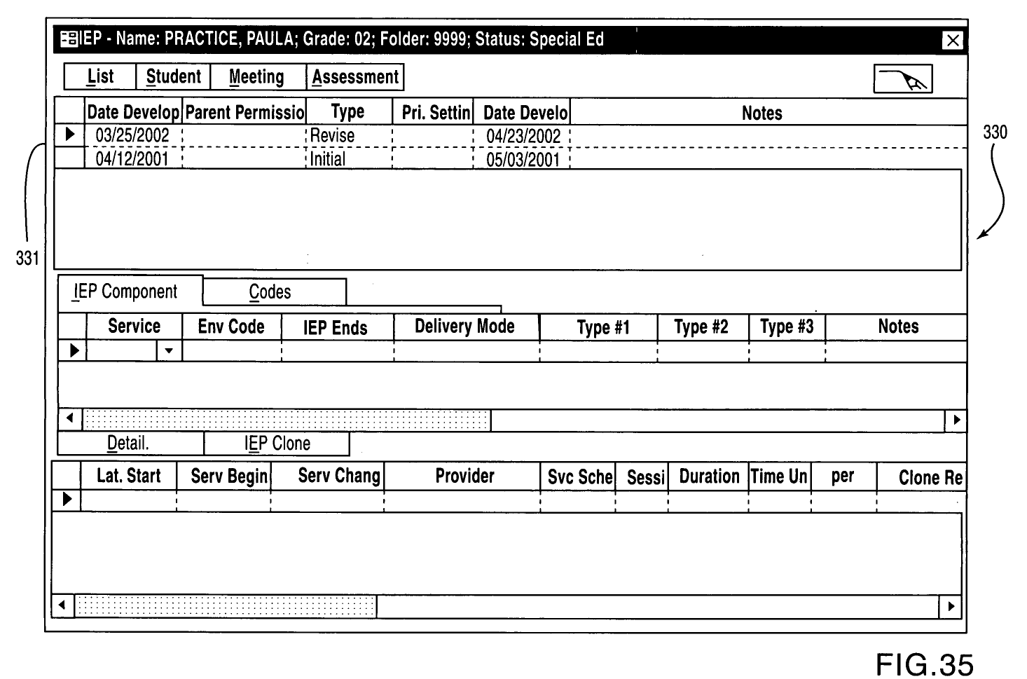

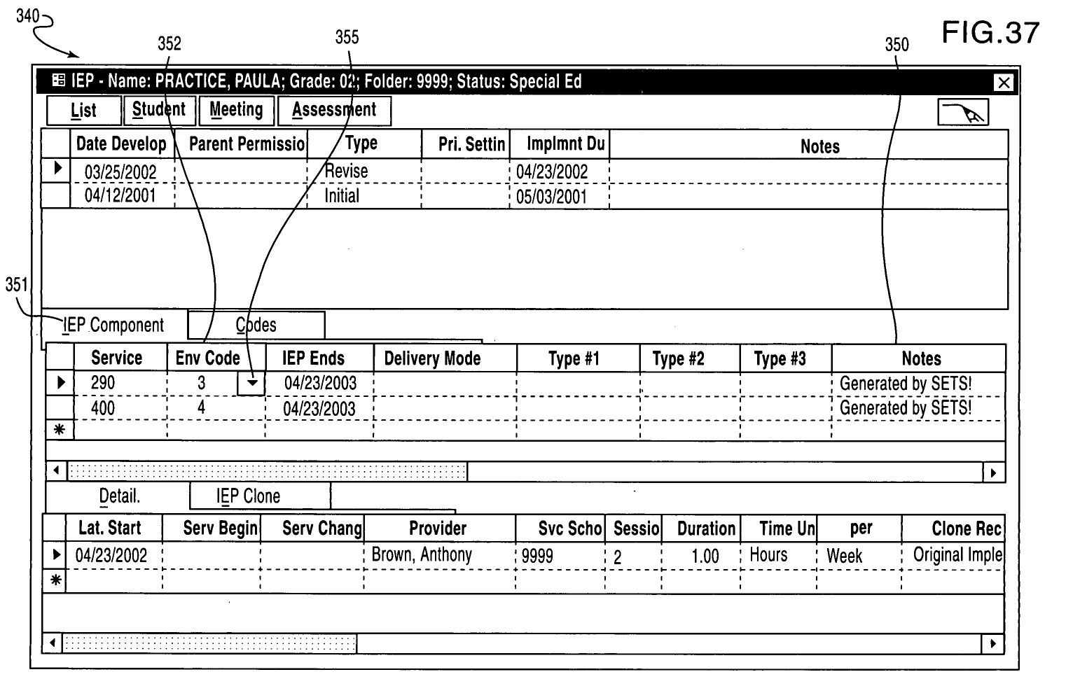

FIGS. 35-37 will now be used to describe an example revision of IEP Services:

1. The IEP revisions option is first accessed. For example, as shown, in FIG. 34, at the top of the Meetings screen 300, the accessor is able to click anywhere on the line of the Post-Initial meeting 310 for which data were entered above in conjunction with FIGS. 33 and 34.

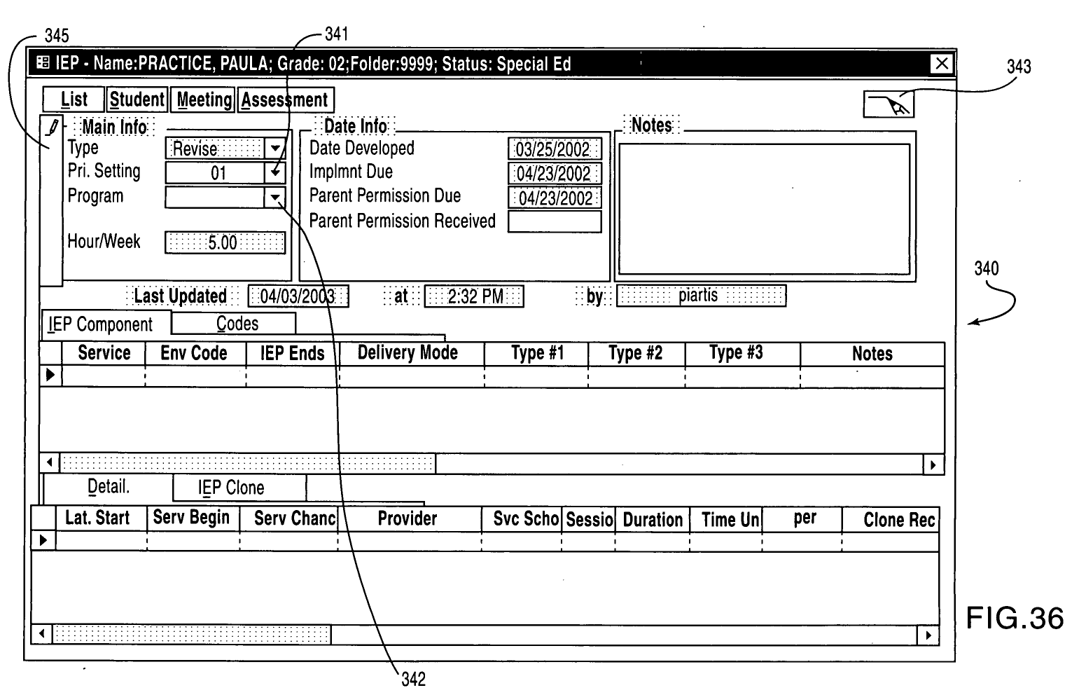

2. The IEP button 329 at the top of the Meeting screen 300 is then selected, which opens the IEP Screen 330, as shown in FIG. 35. 3. At the top of the IEP screen 330, the record box 331 for the date Mar. 25, 2002 is selected to reveal the Main Info form 340, as shown in FIG. 36.

4. In this example, the down arrow 341 of the Pri. Setting box is used to select item 01 General Education Setting.

5. The down arrow 342 of the Program box is then used to select LD—Learning Disabled. Note that in this example and application, because Parent Permission is not required for a Post-Initial, it is not necessary to enter data in this field.

6. If the services have not changed, another feature of the present invention, referred to as the Clone Pencil 343, which is located in the upper right corner of the IEP screen, can be used to copy the previous services to the current year.

7. The data is then confirmed (e.g., by selecting an OK button or the Save Pencil 345). In this example implementation, the system also generates a notice in the note field 350, indicating that certain information has been generated by the system.

8. In the IEP Component section 351, the Env Code field 352 is used to select service “290”, and the down arrow 355 is used to choose 3—Resource Room.

9. In the IEP Component section 351, the Env Code field 352 is also used to select service “400”, via a down arrow used to choose 4—Basic (SE Class).

Another example implementation of the present invention will now be used to perform functions relating to Multidisciplinary Evaluation Team (MET) reviews of a student's assessment results and the making of recommendations to the IEPT team. In this new and separate example, the meeting is to occur within (30) school days of obtaining parental approval to evaluate the child.

A copy of the results and an initial MET meeting notification must be submitted to the student's parent(s)/guardian(s) within twenty-one (21) schools days of the receipt of parental consent to evaluate. Results are sent to the parent(s)/guardian(s) at least seven (7) calendar days prior to the meeting.

The following initial preparation steps are taken first:

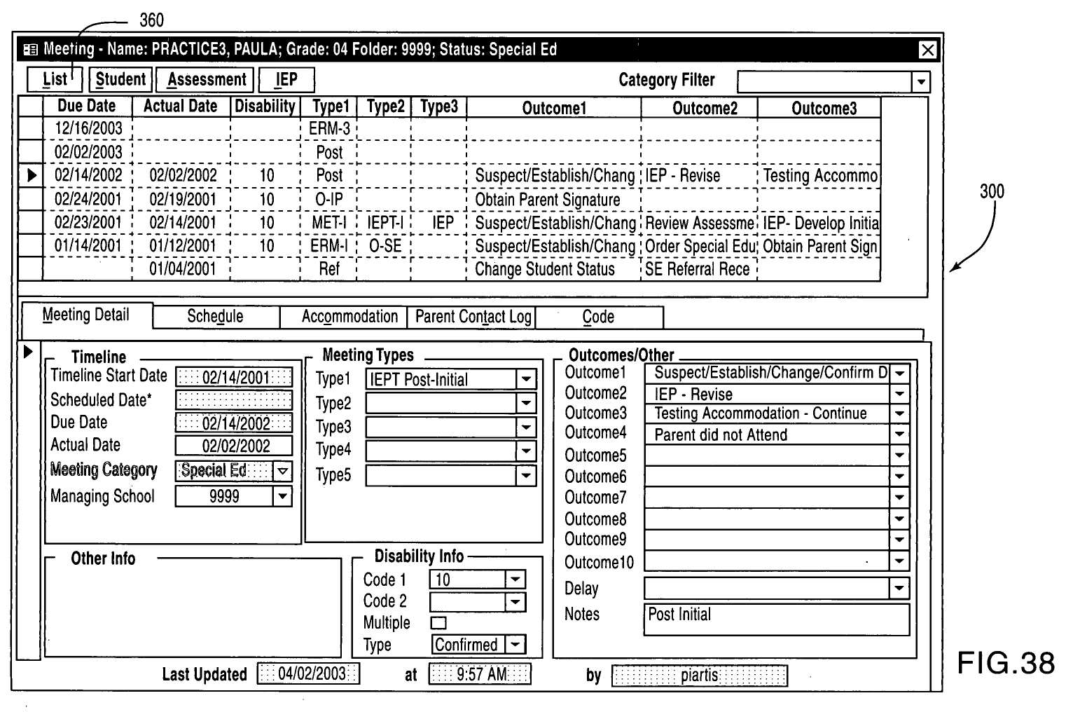

1. The List button 360 in the upper left corner of a Meetings screen 300, such as for the example shown in FIG. 38, is selected.

2. The Look Up Student button in the upper left corner of the Student List screen, which then appears, is used (see, e.g., FIG. 22 for an example screen, and corresponding description).

3. In the ID field of the Student List screen, the ID number of a student is then input (see, e.g., FIG. 23 and corresponding description). To Record an Initial MET, the following actions are taken:

1. The Meeting button in the lower left corner of the Student List screen (see, e.g., FIG. 25) is selected, which produces a Meeting screen, such as the Meeting screen 300 shown in FIG. 38.

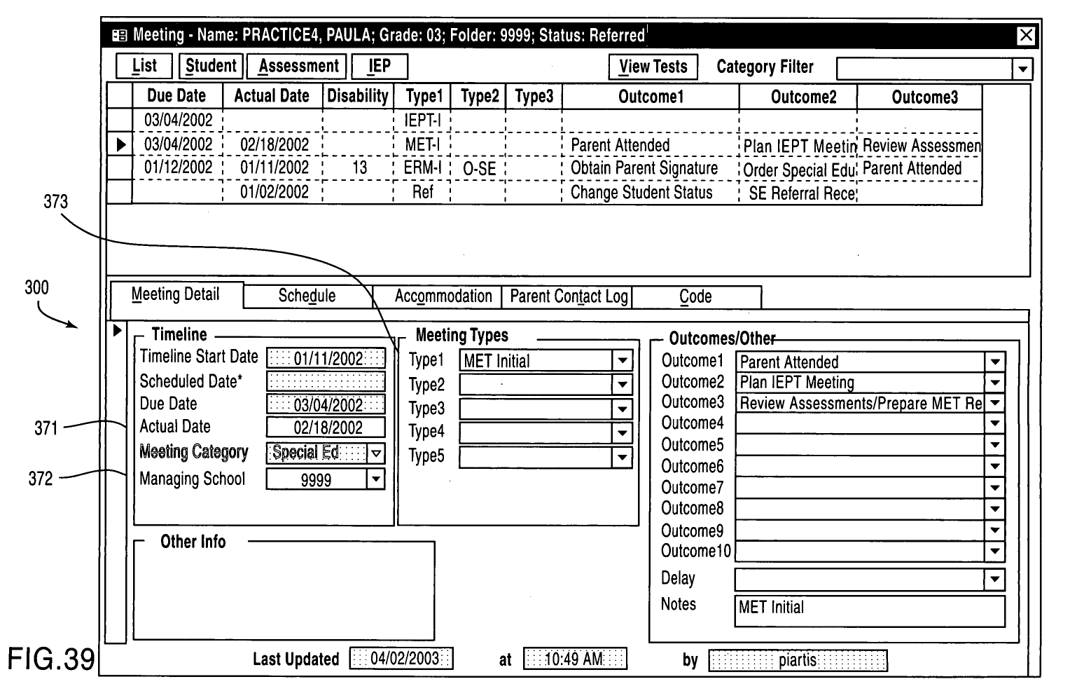

2. In the Actual Date field (see, e.g., Actual Date field 371 in FIG. 39), a date is entered.

3. In the Managing School field 372, a school is selected.

4. In the Meeting Type 1 field 373, MET Initial is selected.

5. The down arrow 374 for the Outcome 1 field is then used to select Parent Attended.

6. The down arrow 375 for the Outcome 2 field is used to select Review Assessments/Prepare MET Recommendations.

7. The Save Pencil or other save option is used to save the data.

8. Check marks placed in boxes that appear or other selection mechanisms are used for each of the ordered assessment test to allow indication to be made that each test has been reviewed.

9. An exit button, such as box containing an (X) in the upper right hand corner of the window allows the accessor to exit the screen.

In another embodiment of the present invention in accordance with the IDEA implementation example, an Initial IEPT meeting is conducted to determine the student's eligibility for special education services. When a child is found eligible, the IEPT proceeds with developing the initial Individual Education Plan (IEP).

Recordation of an initial IEP plan will now be described:

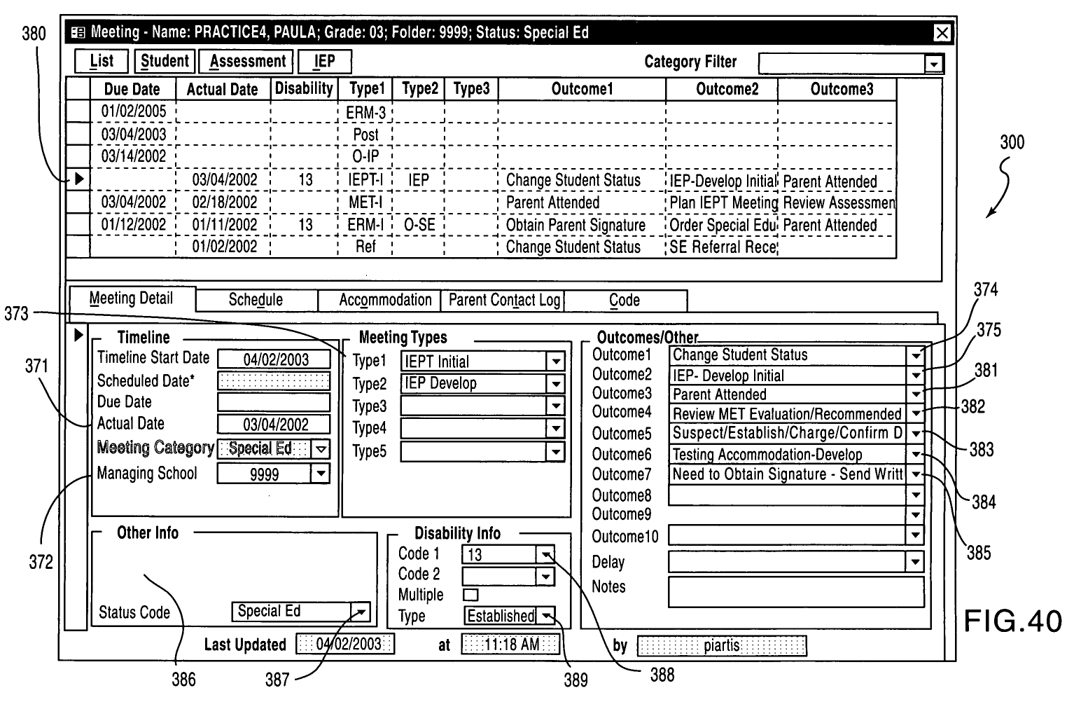

1. At the top of the Meeting screen, such as the Meeting screen 300 shown in FIG. 40, a selection is made anywhere on an IEPT-I meeting line 380, as necessary.

2. In the Actual Date field 371, a date is entered.

3. In the Managing School field 372, a code for a school is entered.

4. In the Meeting Type 2 field 373, click the down arrow and click IEP Develop.

5. The down arrow in the Outcome 1 field 374 is then used to select Change Student Status.

6. The down arrow in the Outcome 2 field 375 is used to select IEP—Develop Initial.

7. The down arrow in the Outcome 3 field 381 is used in this example to select Parent Attended.

8. The down arrow in the Outcome 4 field 382 is used to select Review MET Evaluation/Recommendation.

9. The down arrow in the Outcome 5 field 383 is used to select Suspect/Establish/Change/Confirm Disability.

10. The down arrow in the Outcome 6 field 384 is used to select Testing Accommodation—Develop.

11. The down arrow in the Outcome 7 field 385 is used to select Need to Obtain Signature—Send Written Notice.

12. In the Other Info section 386, the down arrow of the Status Code field 387 is used to select Special Education.

13. In the Disability Code section, the Code 1 box 388 is used to select type 13.

14. The down arrow in the Type field 389 is used to select Established.

15. The Save Pencil or other save option is then used to save the information.

Completion of an Initial ERM will now be described in accordance with the present IDEA implementation example:

1. If necessary, the New Record button on the left side of the toolbar or other button or option is used to create a blank record.

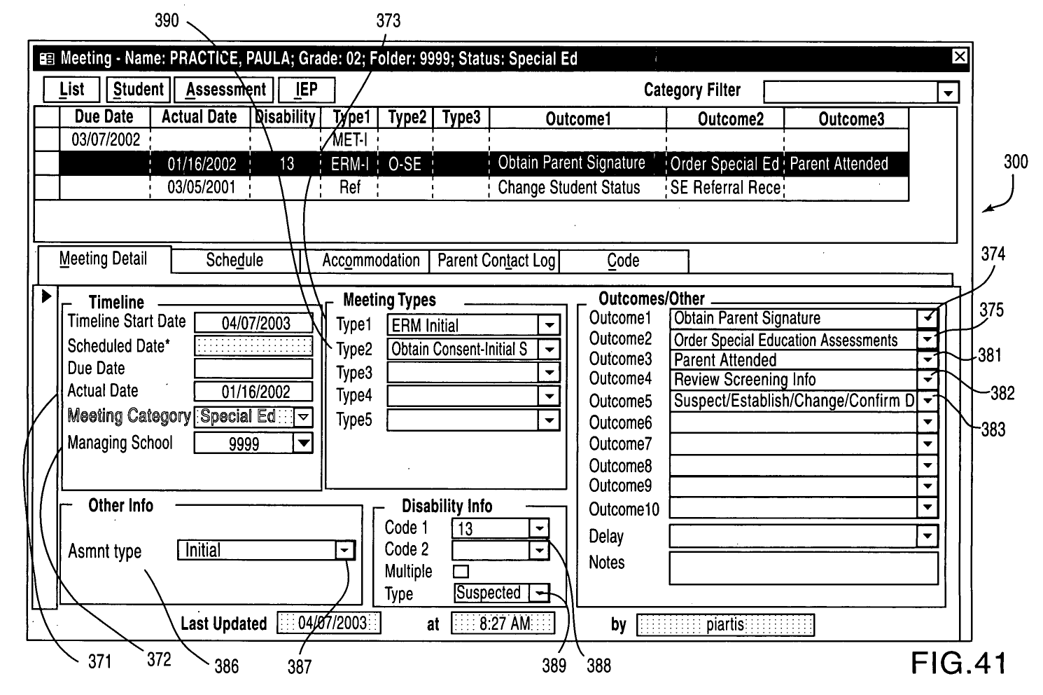

2. As shown in the example GUI screen 300 of FIG. 41, once the blank record is opened, in the Actual Date field 371, the date of the Meeting/Event is input, and then the Managing School field 372 is selected.

3. The appropriate school code for the Meeting/Event is input in the Managing School field 372.

4. In the Type 1 field 373 of the Meeting Types column, the down arrow is used to select ERM Initial.

5. In the Type 2 field 390, the down arrow is used to select Obtain Consent - Initial SE Eval.

6. In the Outcome/Others field, the down arrow 374 of Outcome 1 is used to select Obtain Parent Consent (only if the parent signed) or Need to obtain Signature Send Written Notice.

7. The down arrow 375 of Outcome 2 is used to select Order Special Education Assessments.

8. The down arrow 381 of Outcome 3 is used to select Parent Attended or Parent Did Not Attend.

9. The down arrow 382 of Outcome 4 is used to select Review Screening Info.

10. The down arrow 383 of Outcome 5 is used to select Suspect/Establish/Change/Confirm Disability.

11. In the Other Info section 386, the down arrow 387 is used to select the Assessment Type of Initial.

12. In the Disability Info section, the down arrow 387 of the Code 1 field is used to select the appropriate disability code.

13. In the Type field, the down arrow 389 is used to select Suspected.

14. The Save Pencil on the left side of the Meeting Detail Screen 300 or other mechanism is then used to save the input information.

Functions of the Special Education Enrollment (SEE) Placement process in accordance with an embodiment of the present invention configured for IDEA compliance will now be described in detail. Using available documentation, the student's special education history is entered into the system. The student's eligibility, program placement, grade level, dates of the MET and IEP, ancillary services and any other pertinent information are entered into the appropriate fields in the system. In the Notes fields the term “SEE Placement” may be entered.

Example embodiments of the present invention have now been described in accordance with the above advantages. It will be appreciated that these examples are merely illustrative of the invention. Many variations and modifications will be apparent to those skilled in the art.

1. A method for tailoring a management scheme to a management entity, the method comprising:
identifying management entity specific data options and rules for the management scheme;
determining the management entity specific selections of data options and rules corresponding to master repository data options and rules;
linking the identified management entity specific selections of data options and rules to the corresponding master repository data options and rules; and
for each of the management entity specific selections of data options and rules for which the master repository data options and functions include no corresponding data options and rules, adding the management entity specific selections of data options and rules to an accessible repository;
wherein the management entity specific data options and rules thereby allow prompting, input, and functionality tailored to the management scheme of the management entity.

2. The method of claim 1, wherein the management scheme includes a user interface.

3. The method of claim 2, wherein the prompting, input, and functionality occur via the user interface.

4. The method of claim 3, wherein the data options include selection options for data inputtable via the user interface.

5. The method of claim 1, wherein the management entity specific data options and rules for the management scheme are identified via a timeline.

6. The method of claim 5, wherein the functions include generation of prompts based on the timeline.

7. The method of claim 1, wherein the management scheme includes features for assisting with compliance with Individuals with Disabilities Education Act requirements.

8. The method of claim 1, wherein the management entity specific data options and rules for the management scheme are identified via a matrix.

9. The method of claim 1, further comprising:
preparing a table of non matching rules.

10. The method of claim 1, wherein linking the identified management entity specific selections of data options and rules to the corresponding master repository data options and functions includes:
providing links in at least one business rule table.

11. The method of claim 10, wherein the at least one business rule table includes an event rules table, an assessment rule table, and an Individual Education Plan rule table.

12. The method of claim 10, wherein the at least one business rule table includes an assessment rule table.

13. A method for assisting a management entity with compliance with a management scheme, the management scheme including a plurality of requirements, the method comprising:
receiving data for a subject entity to which the management scheme applies;
identifying each of the plurality of requirements applicable to the subject entity based on the received data;
prompting for additional information to meet each of the plurality of requirements applicable to the subject entity;
receiving the additional information; and
iteratively identifying additional compliance requirements applicable to the subject entity based on the received additional information.

14. The method of claim 13, wherein identifying requirements applicable to the subject entity based on the received data includes:
identifying initial requirements applicable to the subject entity.

15. The method of claim 14, wherein the initial requirements include initial requirements completion timeframes.

16. The method of claim 14, wherein identifying initial requirements applicable to the subject entity includes:
identifying at least one service provider to meet the initial requirements.

17. The method of claim 14, wherein identifying initial requirements applicable to the subject entity includes:
accessing at least one repository of data applicable to compliance with the management scheme.

18. The method of claim 13, wherein identifying each of the plurality of requirements applicable to the subject entity based on the received data includes:
an element of the received data triggering identification of a requirements compliance need; and
providing an accessor with the identified requirements compliance need.

19. The method of claim 18, wherein identifying each of the plurality of requirements applicable to the subject entity based on the received data further includes:
generating at least one additional prompt for accessor input of needed data relating to the identified requirements compliance need.

20. The method of claim 18, wherein identifying each of the plurality of requirements applicable to the subject entity based on the received data further includes:
generating a timeframe for compliance with the identified requirements compliance need.

21. The method of claim 18, wherein the identified requirements compliance need is an Individualized Education Plan for the subject entity.

22. The method of claim 18, wherein the identified requirements compliance need is a meeting.

23. The method of claim 18, wherein the identified requirements compliance need is an assessment.

24. The method of claim 23, wherein the assessment includes at least one test, each of the at least one test varying depending on the plurality of requirements.

25. The method of claim 13, further comprising:
prompting the user to provide information demonstrating compliance with at least one of the plurality of requirements applicable to the subject entity.

26. The method of claim 25, further comprising:
generating compliance documentation for each of the at least one of the plurality of requirements applicable to the subject entity for which the information demonstrating compliance has been provided.

27. The method of claim 13, wherein the management scheme includes a scheme for compliance with the Individuals with Disabilities Act.

28. The method of claim 27, wherein the subject entity is an individual subject to the Individuals with Disabilities Act.

29. The method of claim 27, wherein the management entity is a school.

30. The method of claim 27, wherein the management entity is a school district.

31. The method of claim 27, wherein the management entity is a state.

32. The method of claim 27, wherein the management entity is an association of school districts.

33. A system for assisting a management entity with compliance with a management scheme, the management scheme including a plurality of requirements, the system comprising:
means for receiving data for a subject entity to which the management scheme applies;
means for identifying each of the plurality of requirements applicable to the subject entity based on the received data;
means for prompting for additional information to meet each of the plurality of requirements applicable to the subject entity;
means for receiving the additional information; and
means for iteratively identifying additional compliance requirements applicable to the subject entity based on the received additional information.

34. A system for assisting a management entity with compliance with a management scheme, the management scheme including a plurality of requirements, the system comprising:
a processor;
a user interface functioning via the processor; and
a repository accessible by the processor;
wherein data for a subject entity to which the management scheme applies is received via the user interface and stored in the repository;
wherein each of the plurality of requirements applicable to the subject entity based on the received data is identified via the processor;
wherein additional information to meet each of the plurality of requirements applicable to the subject entity is prompted for via the user interface;
wherein the additional information is received via the user interface; and
wherein additional compliance requirements applicable to the subject entity are iteratively identified based on the received additional information.

35. The system of claim 34, wherein the processor is housed on a terminal.

36. The system of claim 35, wherein the terminal is selected from a group consisting of a personal computer, a minicomputer, a main frame computer, a microcomputer, a hand held device, and a telephonic device.

37. The system of claim 34, wherein the processor is housed on a server.

38. The system of claim 37, wherein the server is selected from a group consisting of a personal computer, a minicomputer, a microcomputer, and a main frame computer.

39. The system of claim 37, wherein the server is coupled to a network.

40. The system of claim 39, wherein the network is the Internet.

41. The system of claim 39, wherein the server is coupled to the network via a coupling.

42. The system of claim 41, wherein the coupling is selected from a group consisting of a wired connection, a wireless connection, and a fiberoptic connection.

43. The system of claim 34, wherein the repository is housed on a server.

44. The system of claim 43, wherein the server is coupled to a network.

45. A computer program product comprising a computer usable medium having control logic stored therein for causing a computer to determine patient treatment information, the control logic comprising:
first computer readable program code means for receiving data for a subject entity to which the management scheme applies;
second computer readable program code means for identifying each of the plurality of requirements applicable to the subject entity based on the received data;
third computer readable program code means for prompting for additional information to meet each of the plurality of requirements applicable to the subject entity;
fourth computer readable program code means for receiving the additional information; and
fifth computer readable program code means for iteratively identifying additional compliance requirements applicable to the subject entity based on the received additional information.
